(19) United States
(12) Patent Application Publication
(10) Pub. No.: US 2026/0140000 A1
(43) Pub. Date: May 21, 2026

(54) A TEST SYSTEM AND METHODS FOR DETERMINING BATTERY THERMAL RUNAWAY CHARACTERISTICS

(71) Applicant: BOARD OF REGENTS, THE UNIVERSITY OF TEXAS SYSTEM, Austin, TX (US)

(72) Inventors: Ofodike A. EZEKOYE, Austin, TX (US); Haotian YAN, Austin, TX (US); Kevin C. MARR, Austin, TX (US)

(21) Appl. No.: 18/705,825

(22) PCT Filed: Oct. 28, 2022
(86) PCT No.: PCT/US2022/048170

§ 371 Date: Apr. 29, 2024

Related U.S. Application Data
(60) Provisional application No. 63/273,592, filed on Oct. 29, 2021.
(60) Provisional application No. 63/337,667, filed on May 3, 2022.

(51) Int. Cl. G01K 17/00; H01M 10/42; H01M 10/48

(52) U.S. Cl. CPC G01K 17/00; H01M 10/4285; H01M 10/486

(57) ABSTRACT

Disclosed is a system comprising at least one test electrochemical energy storage device having an internal compartment and an external surface, wherein the internal compartment comprises: i) a negative electrode; ii) a positive electrode; iii) a temperature sensor; and iv) a heating device; wherein the temperature sensor and the heating device are positioned within at least a portion of the internal compartment of the at least one test electrochemical energy storage device; and wherein the system is configured to initiate internal reactions and trigger thermal runaway of at least one test electrochemical energy storage device and/or one or more electrochemical energy storage devices.

### CROSS-REFERENCE TO RELATED APPLICATIONS

This application claims the benefit of U.S. Provisional Application No. 63/273,592, filed Oct. 29, 2021, and U.S. Provisional Application No. 63/337,667, filed May 3, 2022, the contents of which are incorporated herein by reference in their entirety.

### STATEMENT ACKNOWLEDGING GOVERNMENT SUPPORT

This invention was made with government support under Grant No. 2018-MU-BX-0004, awarded by the National Institute of Justice. The government has certain rights in the invention.

### TECHNICAL FIELD

This application relates generally to the systems and methods used to determine thermal runaway characteristics.

### BACKGROUND

Since Volta invented the “true battery” in 1800, electrochemical cells (i.e., batteries) have become so essential that it is impossible to envision modern life's existence without batteries. All aspects of humankind's life today require the use of batteries. A magnitude of various applications requires a wide variety of batteries both from an energy storage perspective and from a size perspective.

Various rechargeable electrochemical systems (e.g., lithium-ion, sodium-ion, zinc-ion chemistries) are used in various current and proposed applications, ranging from personal digital devices (e.g., laptops and phones) to electric mobility vehicles (e.g., electric vehicles, scooters, bicycles, etc.). With technological improvements in energy and power density, cycling life, and sustainability of batteries, rechargeable battery-powered electronic applications are becoming more prevalent.

However, the growing production of cells of varying quality also leads to increasing reports of fires from electronic devices and electric vehicles, causing public concerns about rechargeable batteries, specifically Li-ion batteries' fire safety. Due to any number of external abuse or internal failure conditions, batteries can catch on fire. When it comes to battery fire safety, the primary concern is the battery's internal failure, which can lead to thermal runaway, given a sufficient state-of-charge (SOC) within a cell. Thermal runaway occurs when the heat generation rate exceeds the heat dissipation rate, which leads to rapidly increasing temperatures. To prevent thermal runaway, internal safety mechanisms such as positive temperature coefficient (PTC) fuses and current interrupt devices (CID) have been incorporated into some cylindrical format batteries (for example, Li batteries of a 18650 type). Additional protective measures, such as liquid cooling, insulation between cells, and heat sinks, are commonly engineered to supplement internal cell safety mechanisms in multi-cell battery packs. These solutions work to complement each other in assuring overall system safety.

All battery safety systems should be evaluated for cell failure in close to “real-world” conditions. Failure testing aims to induce battery failures that are representative of “real-world” field failures. Setting up such scenarios can be challenging, yet pivotal to assure the feasibility of the designed mechanisms in real-life applications. Despite the increasing literature on approaches to initiate battery thermal runaway thermally (e.g., overheating), mechanically (e.g., compression), electrically (e.g., overcharge), and internally (e.g., internal short circuit and self-heating), relatively little information is available to battery designers and manufacturers on creating a practical battery internal failure scenario due to the challenges inherent in producing internal failure in a simple, realistic, repeatable, and controllable manner.

In this disclosure, cylindrical 18650 Li-ion cells were considered. To induce internal failure, a variety of approaches are considered by researchers. One of the most common and accessible approaches is the mechanical abuse tests which can involve crush and nail penetration, blunt rod, and pinch tests.

These tests typically require an external device to mechanically deform the cell and trigger cell failure. Although easy to conduct on a single cell, the results from Liu et al. show poor repeatability, and such tests are difficult to conduct in enclosed battery modules.

Another approach to trigger thermal runaway in groups of cells is to replace one or more of the cells in the pack with a heating element. The dynamics of failure associated with this approach cannot duplicate the failure associated with a true cell failure, which would include direct heating by the hot cell and heating by hot-vented products generated in the primary cell failure. As such, it is desirable to initiate an internal failure within any given cell to allow this failure to more accurately model the actual failure processes seen in real cell failures.

An approach was developed by Keyser et al. from the National Renewable Energy Laboratory (NREL), using an on-demand activation device to trigger an internal short circuit (ISC). The device consisted of four layers: a copper pad, a separator with a copper puck at the center, a wax layer that melted at 57° C., and an aluminum pad. A hole was cut in the separator into which the device was placed. As the wax was heated up, it melted and was wicked away by the separator, thus creating a contact between the negative carbon electrode and the positive Al current collector to trigger ISC. The phase-change-material (PCM) approach is able to induce an internal failure in a repeatable manner but requires the fabrication of the controllable device and cell assembly in a glove box or dry room.

However, thus far, no literature has been found to use this approach to study cell failure in a large battery pack. In general, an ideal battery internal failure approach should involve (1) simple preparation procedures with standard lab equipment and easily accessible materials; (2) minimal changes to the battery's performance after the preparation; (3) consistent setup and repeatable results (heating rate); (4) realistic thermal runaway behavior and damage as those in practical conditions; and (5) controllable trigger in enclosures (e.g., in laptops, power tools, battery modules, etc.).

In this disclosure, an ISC approach is introduced to fulfill the above requirements and simulate internal failure in any cylindrical format cell battery pack, particularly commercial devices and appliances, for the development of safety mechanisms.

### SUMMARY

The present disclosure is directed to a system comprising at least one test electrochemical energy storage device having an internal compartment and an external surface, wherein the internal compartment comprises: i) a negative electrode; ii) a positive electrode; iii) a temperature sensor; and iv) a heating device; wherein the temperature sensor and the heating device are positioned within at least a portion of the internal compartment of the at least one test electrochemical energy storage device; and wherein the system is configured to initiate internal reactions and trigger thermal runaway of at least one test electrochemical energy storage device and/or one or more electrochemical energy storage devices.

In still further aspects, the at least one test electrochemical energy device is cylindrical.

In yet further aspects, the one or more electrochemical energy storage devices have substantially identical geometry to the at least one test electrochemical energy storage device. While in still further aspects, the one or more electrochemical energy storage devices have a substantially identical composition as compared to the at least one test electrochemical energy storage device in the absence of at least the heater device and/or the temperature sensor.

In yet further aspects, the at least one test electrochemical energy storage device and one or more electrochemical energy storage devices are lithium-ion cells.

In yet further aspects, disclosed herein is a method comprising: a) providing at least one test electrochemical energy storage having an internal compartment and an external surface, wherein the internal compartment comprises: i) a negative electrode; ii) a positive electrode; iii) a temperature sensor; and iv) a heating device; wherein the temperature sensor and heating device are positioned within at least a portion of the internal compartment of the at least one test electrochemical energy storage device; and b) heating the at least one test electrochemical energy storage device to cause an internal failure.

In still further aspects, the methods also comprise a step of modeling one or more of the thermal properties, reactive/kinetic properties, a degradation path, and/or stability of active materials of one or more electrochemical energy storage devices that are substantially identical to the at least one test electrochemical energy storage device with the absence of at least the heater device and/or the temperature sensor.

In yet still further aspects, the at least one test electrochemical energy storage device used in the methods of the instant disclosure is formed by inserting the temperature sensor and the heating device into at least a portion of an internal compartment of one or more electrochemical energy storage devices. In such aspects, the at least one test electrochemical energy storage device and one or more electrochemical energy storage devices are lithium-ion cells.

In still further aspects, the methods further comprise inserting the at least one test electrochemical energy storage device into a pack comprising the one or more electrochemical energy storage devices prior to the step of heating.

Also disclosed herein are modules for real-time thermal behavior analysis of a test electrochemical energy storage device, the module comprising: a) the test electrochemical energy storage device, b) a high thermal conductivity surrogate heater element; and c) a control unit that is in electrical communication with the test electrochemical energy storage device and the high thermal conductivity surrogate heater element and is configured to heat the test electrochemical energy storage device and the high thermal conductivity surrogate heater element independently to a first predetermined temperature and a second predetermined temperature, respectively, and wherein the control unit is further configured to collect and process data to analyze a thermal behavior of the test electrochemical energy storage device, wherein the test electrochemical energy storage device has an internal compartment and an external surface, wherein the internal compartment comprises: i) a negative electrode; ii) a positive electrode; iii) a temperature sensor; and iv) a heating device, wherein the temperature sensor and the heating device are positioned within at least a portion of the internal compartment of the at least one test electrochemical energy storage device.

Still further disclosed are methods of analyzing a thermal behavior of any of the disclosed herein test electrochemical energy storage devices, comprising: a) heating the internal compartment to a temperature; b) equilibrating a temperature of the external surface of the test electrochemical energy storage device with the temperature of the internal compartment; c) heating a high thermal conductivity surrogate heater element to match the temperature of the external surface of the test electrochemical energy storage device; d) continue heating the internal compartment until a thermal runaway of the test electrochemical energy storage device is initiated; e) heating a surface of the high thermal conductivity surrogate heater element to match a temperature of up to a predetermined value of the test electrochemical energy storage device; and f) estimating the thermal behavior of the test electrochemical energy storage device.

Also disclosed herein an additional module for real-time thermal behavior analysis of a test electrochemical energy storage device, the module comprising: a) a test electrochemical energy storage device having an internal compartment and an external surface, wherein the internal compartment comprises: i) a negative electrode; ii) a positive electrode; iii) a temperature sensor; and iv) a heating device; wherein the temperature sensor and the heating device are positioned within at least a portion of the internal compartment of the at least one test electrochemical energy storage device; and b) a control unit that is in electrical communication with the test electrochemical energy storage device and that is configured to independently heat the internal compartment and the external surface of the test electrochemical energy storage device to a first temperature and to a second temperature respectively, and wherein the control unit is further configured to collect and process data to analyze a thermal behavior of the test electrochemical energy storage device.

Still further disclosed herein are methods of analyzing a thermal behavior of any of the disclosed herein test electrochemical energy storage devices, the method comprising: a) heating the internal compartment to a temperature; b) heating the external surface of the test electrochemical energy storage device to match the temperature of the internal compartment of the test electrochemical energy storage device; c) continue heating the internal compartment until a thermal runaway of the test electrochemical energy storage device is initiated; and d) estimating the thermal behavior of the test electrochemical energy storage device.

Additional advantages will be set forth in part in the description which follows, and in part will be obvious from the description or can be learned by practice of the aspects described below. The advantages described below will be realized and attained by means of the chemical compositions, methods, and combinations thereof, particularly pointed out in the appended claims. It is to be understood that both the foregoing general description and the following detailed description are exemplary and explanatory only and are not restrictive of the invention, as claimed.

### BRIEF DESCRIPTION OF DRAWINGS

FIGS. 1A-1E depict a schematic of an exemplary commercially available electrochemical storage device (lithium-ion cell 18650 type) (FIG. 1A); a cross-sectional view of lithium-ion cell 18650 type (FIGS. 1B-1C) photograph of an exemplary test electrochemical storage device according to one aspect (FIG. 1D) and an exemplary internal schematics of the test cell shown in FIG. 1D (FIG. 1E).

FIGS. 2A-2B show a voltage profile of the test electrochemical storage device of FIG. 1D and an exemplary electrochemical storage device according to one aspect (FIG. 2A) and a capacity profile of the test electrochemical storage device of FIG. 1D and an exemplary electrochemical storage device (FIG. 2A) according to one aspect.

FIGS. 3A-3B show photographs of the failure tube setup: FIG. 3A-external heating setup; FIG. 3B-internal heating setup.

FIGS. 4A-4B depict mass loss test schematics of internal (FIG. 4A) and external (FIG. 4B) heating.

FIGS. 5A-5C depict a photograph of inserting the test electrochemical storage device of FIG. 1D into an exemplary laptop power bank (FIG. 5A); a photograph of the back portion of the exemplary laptop power bank showing the thermocouple and heater wiring setup (FIG. 5B), and a photograph of the laptop setup in the test facility (FIG. 5C).

FIGS. 6A-6C depict a temperature profile of external heating (100% SOC) of a surface in an air and inert environment (FIG. 6A); a temperature profile of internal heating (100% SOC) of a surface in air and inert environment (FIG. 6B) and a temperature profile of internal heating (100% SOC) of the center in air and inert environment (FIG. 6C). The vertical dashed lines mark the heater turning on (60 s for external heating and 180 s for internal heating) and vent openings. Test 1:179.2 s; Test 2:184.5 s, and Test 3:184.7 s.

FIGS. 7A-7B depict a temperature profile of external heating (100% SOC) (FIG. 7A); a temperature profile of internal heating (100% SOC) (FIG. 7B). The vertical dashed lines mark the heater turning on (60 s for external heating and 180 s for internal heating).

FIGS. 8A-8C show a temperature profile of external heating at varying SOC of a surface (FIG. 8A); a temperature profile of internal heating at varying SOC of a surface (FIG. 8B); and a temperature profile of internal heating at varying SOC of a center (FIG. 8C) The vertical dashed lines mark the heater turning on (180 s). 100%: 314.3 s; 70%: 360.1 s; 50%: 362.5 s; 30%: 360.2 s; 0%: 380.3 s.

FIGS. 9A-9B depict a temperature profile of external heating (0% SOC) (FIG. 9A); a temperature profile of internal heating (0% SOC) (FIG. 9B). The vertical dashed line marks the vent opening (232 s).

FIGS. 10A-10B depict a surface temperature and voltage profile at high power (125 W) external heating (100% SOC) (FIG. 10A); a surface temperature and voltage profile of at low power (20 W) external heating (100% SOC) (FIG. 10B) The vertical dashed line marks the heater turning on (60) and vent openings. 125 W: 195.6 s; 20 W: 1168.7 s.

FIGS. 11A-11B show a comparison of commercially available methods (FIG. 11A) and methods disclosed on one aspect (FIG. 11B). FIG. 12A-shows an internal short circuit induced by Phase Change Material (PCM) (see Darcy, Insights from safety tests with an on-demand internal short circuit device in 18650 cells (2017)). FIG. 11B shows the internal heating of the 100% SOC test electrochemical storage device of FIG. 1D. Vertical dashed line marks the heater turned on (180 s).

FIG. 12 shows a mass loss profile of external and internal heating tests at varying SOCs in an air environment. Vertical dashed line marks the vent opening.

FIGS. 13A-13B show a temperature profile of laptop runaway induced by a surrogate cell heater structure according to one aspect (FIG. 13A) and a temperature profile of laptop runaway induced by a test electrochemical storage device according to another aspect (FIG. 13B).

FIGS. 14A-14C depict a schematic of the device used for thermal modeling (FIG. 14A); a schematic of various heating points and a photograph of testing devices (FIG. 14B); a profile of the measured and modeled temperatures of the test device according to one aspect (FIG. 14C).

FIG. 15 shows a schematic for calorimetric measurements in one aspect.

FIG. 16 shows a schematic for calorimetric measurements in a different aspect.

FIGS. 17A-17B show exemplary components of a calorimeter system.

FIG. 17A depicts a heater-insertion system, and FIG. 17B depicts a benchmarking system.

FIG. 18 shows an exemplary apparatus for a calorimeter system.

The accompanying figures, which are incorporated in and constitute a part of this specification, illustrate several aspects described below.

### DETAILED DESCRIPTION

The present invention can be understood more readily by reference to the following detailed description, examples, drawings, and claims, and their previous and following description. However, before the present articles, systems, and/or methods are disclosed and described, it is to be understood that this invention is not limited to the specific or exemplary aspects of articles, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

### Definitions

As used herein, the terms “optional” or “optionally” mean that the subsequently described event or circumstance can or cannot occur and that the description includes instances where said event or circumstance occurs and instances where it does not.

It is appreciated that certain features of the disclosure, which are, for clarity, described in the context of separate aspects, can also be provided in combination in a single aspect. Conversely, various features of the disclosure, which are, for brevity, described in the context of a single aspect, can also be provided separately or in any suitable subcombination.

As used in the description and the appended claims, the singular forms “a,” “an,” and “the” include plural referents unless the context clearly dictates otherwise. Thus, for example, a reference to “a functional additive” includes two or more such functional additives, reference to “a battery” includes two or more such batteries and the like.

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims, which follow, reference will be made to a number of terms that shall be defined herein.

For the terms “for example” and “such as” and grammatical equivalences thereof, the phrase “and without limitation” is understood to follow unless explicitly stated otherwise.

The expressions “ambient temperature” and “room temperature” as used herein are understood in the art and refer generally to a temperature from about 20° C. to about 35° C.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values, inclusive of the recited values, may be used. Further, ranges can be expressed herein as from “about” one particular value and/or to “about” another particular value. When such a range is expressed, another aspect includes from the one particular value and/or to the other particular value.

Similarly, when values are expressed as approximations, by use of the antecedent “about,” it will be understood that the particular value forms another aspect. It will be further understood that the endpoints of each of the ranges are significant both in relation to the other endpoint and independently of the other endpoint. Unless stated otherwise, the term “about” means within 5% (e.g., within 2% or 1%) of the particular value modified by the term “about.”

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”).

As used herein, the term “and/or” includes any and all combinations of one or more of the associated listed items.

It will be understood that although the terms “first,” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

As used herein, the term “substantially” means that the subsequently described event or circumstance completely occurs or that the subsequently described event or circumstance generally, typically, or approximately occurs.

Still further, the term “substantially” can, in some aspects, refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is then about 1% by weight, e.g., less than about 0.5% by weight, less than about 0.1% by weight, less than about 0.05% by weight, or less than about 0.01% by weight of the stated material, based on the total weight of the composition.

As used herein, the terms “substantially identical reference composition,” “substantially identical reference article,” or “substantially identical reference electrochemical cell” refer to a reference composition, article, or electrochemical cell comprising substantially identical components in the absence of an inventive component. In another exemplary aspect, the term “substantially,” in, for example, the context “substantially identical reference composition,” or “substantially identical reference article,” or “substantially identical reference electrochemical cell,” refers to a reference composition, article, or an electrochemical cell comprising substantially identical components and wherein an inventive component is substituted with a common in the art component.

The disclosed herein systems are configured to initiate a “trigger mechanism” by which internal short circuits within the test electrochemical energy storage device could be created for safety standard testing applications. The ability to repeatability initiates thermal runaway failures is considered the “holy grail” of lithium-ion battery safety research that assists in evaluating the safety boundaries of commercial and research batteries and helps create safer products.

While aspects of the present invention can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to the arrangement of steps or operational flow, plain meaning derived from grammatical organization or punctuation, or the number or type of aspects described in the specification.

The present invention may be understood more readily by reference to the following detailed description of various aspects of the invention and the examples included therein and to the Figures and their previous and following description.

### Systems

As disclosed above, the current disclosure is directed to at least one test electrochemical energy storage device having an internal compartment and an external surface, wherein the internal compartment comprises: i) a negative electrode; ii) a positive electrode; iii) a temperature sensor; and iv) a heating device.

It is understood that in the aspect disclosed herein, a temperature sensor can be understood as at least one temperature sensor and a heating device as at least one heating device. It is also understood that more than one temperature sensor or temperature device can be present in the disclosed herein electrochemical energy storage devices.

In still further aspects, the temperature sensor and the heating device are positioned within at least a portion of the internal compartment of the at least one test electrochemical energy storage device.

In yet other aspects, the disclosed herein system is configured to initiate internal reactions and trigger thermal runaway of at least one test electrochemical energy storage device and/or one or more electrochemical energy storage devices.

It is understood that the at least one test electrochemical energy device and the one or more electrochemical energy storage devices can have any acceptable in the industry shape. In certain aspects, the at least one test electrochemical energy device is cylindrical. In yet other aspects, the one or more electrochemical energy storage devices have substantially identical geometry to the at least one test electrochemical energy storage device. In still further exemplary and unlimiting aspects, if the at least one test electrochemical energy device and/or the one or more electrochemical energy storage devices are cylindrical, such devices can have other configurations. In yet still further aspects, the disclosed herein test electrochemical energy devices and one or more electrochemical energy storage devices are not limited to a specific size and can be adapted to any size known in the industry.

In still further aspects, the one or more electrochemical energy storage devices have a substantially identical composition as compared to the at least one test electrochemical energy storage device in the absence of at least the heating device and/or the temperature sensor.

In still further aspects, the one or more electrochemical energy storage devices exhibit substantially identical electrical properties as the at least one test electrochemical energy storage device.

In still further aspects, the disclosed herein test electrochemical energy devices, and the one or more electrochemical energy storage devices are lithium-ion batteries.

In such aspects, the negative and positive electrodes comprise any materials known in the lithium ion cells. In still further aspects, the disclosed herein test electrochemical energy devices, and the one or more electrochemical energy storage devices can further comprise an electrolyte. Again, any known in the art of lithium-ion cell electrolytes can be utilized.

It is understood, however, that the disclosed herein test electrochemical energy devices and the one or more electrochemical energy storage devices are not limited to lithium-ion cells and can also comprise sodium and/or potassium batteries.

In still further aspects, the disclosed herein temperature sensors can comprise any known in the art and applicable to the desired application temperature sensors. It is understood that the temperature sensor can be any sensor configured to precisely measure a temperature of the desired subject, whether it is the temperature within the internal compartment of the device or the temperature of an external surface of the device.

For example, and without limitations, the temperature sensors can comprise one or more thermocouples, one or more resistance-based sensors (such as negative temperature coefficient (NTC) thermistors or other resistance temperature detectors (RTDs)), one or more thermopile sensors, or any combination thereof.

In still further aspects, the heating device can be any known in the art device having the desired dimensions and capable of heating the test electrochemical energy devices to the desired temperature.

In certain aspects, the temperature sensor can be positioned anywhere within the internal compartment of the at least one test electrochemical energy storage device as desired. It is understood that special care needs to be taken to place the thermal sensor such that undesirable contact with the other component of the test device is avoided. In yet other aspects, the temperature sensor is positioned in the center of the internal compartment of the at least one test electrochemical energy storage device.

In yet other aspects, the heating device can be positioned anywhere within the internal compartment of the at least one test electrochemical energy storage device. Again, it is understood that the heating device needs to be positioned such that any undesirable contact with other components of the test device is substantially avoided. In still further aspects, the heating device is positioned in a center of the internal compartment of the at least one test electrochemical energy storage device.

In yet further aspects, the heating device is configured to heat the internal compartment of the at least one test electrochemical energy storage device to a predetermined temperature. For example and without limitations, the predetermined temperature can be from about 60° C. to about 1,500° C., including exemplary values of about 100° C., about 150° C., about 200° C., about 250° C., about 300° C., about 350° C., about 400° C., about 450° C., about 500° C., about 550° C., about 600° C., about 650° C., about 700° C., about 750° C., about 800° C., about 850° C., about 900° C., about 950° C., about 1,000° C., about 1,050° C., about 1,100° C., about 1,150° C., about 1,200° C., 1,250° C., about 1,300° C., about 1,350° C., about 1,400° C., and about 1,450° C.

In still further aspects, the internal compartment can further comprise any known in the art and suitable for the specific application of thermally conductive materials. For example, the internal compartment can comprise a thermal paste or a metal slug. The metal slug can be made of any metal suitable for the desired application. For example, the metal slug can be made from aluminum. Some exemplary configurations are shown in the figures and described in the exemplary section.

In still further aspects, the system disclosed herein can comprise a control unit. In such aspects, the control unit is in electrical communication with at least the temperature sensor and/or the heating device. In yet still further aspects, the control system is configured to process input and output data received from the at least the temperature sensor and/or the heating device and to develop a prediction model of the test device if needed. In yet still further aspects, the control system is in feedback loop communication with the at least the temperature sensor and/or the heating device.

In certain exemplary and unlimiting aspects, the system can further comprise a surrogate cell heater element. In such aspects, the at least one test electrochemical energy storage device and the surrogate cell heater element can be configured to be heated independently to a first temperature and a second temperature, respectively. For example, in such exemplary and unlimiting aspects, the at least one test electrochemical energy storage device can be heated by the heating device positioned with the test device, and the surrogate cell heater can be independently heated. However, it is understood that aspects where the heating device within the internal compartment of the test device and the surrogate cell heater are both controlled by the described herein control unit are also disclosed.

It is understood that the heating device and/or the surrogate cell heater can be operated continuously or in “step and hold” mode depending on the desired application.

Also disclosed herein are aspects where the first temperature and the second temperature are the same. Yet, in other aspects, the first temperature and the second temperature can be different.

In certain aspects, the external surface of the at least one test electrochemical energy storage device and the internal compartment of the at least one test electrochemical energy storage device are configured to be heated independently to a third and a fourth temperature, respectively. In some aspects, the third and fourth temperatures are the same. While in other aspects, the third and the fourth temperatures are different.

In still further aspects, the disclosed herein system is configured to provide calorimetric characteristics of the at least one test electrochemical energy storage device. For example, and without limitations, the disclosed herein system can be configured to characterize thermal properties, reactive/kinetic properties, a degradation path, and/or stability of active materials in the at least one test electrochemical energy storage device. Yet, in still further aspects, the system can also be configured to model thermal properties, reactive/kinetic properties, a degradation path, and/or stability of active materials of the one or more electrochemical energy storage devices.

In still further aspects, the system itself can also comprise the one or more electrochemical energy storage devices.

In still further aspects, the systems disclosed herein are fail-safe. It is understood that due to the heating device being positioned within the internal compartment of the test device and due to the heating device continuously heating the test device, the test device will be heated to a high enough temperature to trigger the device into the thermal runaway.

Also disclosed herein are aspects directed to modules for real-time thermal behavior analysis of test electrochemical energy storage devices. In some aspects, the module can comprise: the test electrochemical energy storage device to be examined, a high thermal conductivity surrogate heater element, and a control unit that is in electrical communication with the test electrochemical energy storage device and the high thermal conductivity surrogate heater element and is configured to heat the test electrochemical energy storage device and the high thermal conductivity surrogate heater element independently to a first predetermined temperature and a second predetermined temperature respectively, and wherein the control unit is further configured to collect and process data to analyze the thermal behavior of the test electrochemical energy storage device. The test electrochemical energy storage devices used in such modules can be any of the disclosed herein test electrochemical energy storage devices. In certain aspects, the test electrochemical energy storage devices can have an internal compartment and an external surface, wherein the internal compartment comprises: i) a negative electrode; ii) a positive electrode; iii) a temperature sensor; and iv) a heating device; wherein the temperature sensor and the heating device are positioned within at least a portion of the internal compartment of the at least one test electrochemical energy storage device.

Again any of the disclosed herein test electrochemical energy storage devices can be utilized. For example, the test electrochemical energy storage devices present in the disclosed modules can have a cylindrical shape. However, other shapes and sizes are also contemplated depending on the desired application.

In yet further aspects, the modules disclosed herein can comprise the high thermal conductivity surrogate heater element having a cylindrical shape and having a geometry substantially identical to the test electrochemical energy device.

It is understood that the data analysis can be performed by any method known in the art and suitable for the desired application. In certain aspects, the data analysis is performed by a computational device. In yet other aspects, the system can comprise a processor configured to obtain data, analyze it accordingly to the desired models, and provide the requested output information.

As disclosed above, the test electrochemical energy storage device of the disclosed modules can be lithium-ion cells. Yet, in other aspects, they can be potassium or sodium-based cells.

Similarly to the disclosed above, the at least one test electrochemical energy storage device present in the disclosed modules can have the heating device to be positioned in a center of the internal compartment of the test electrochemical energy storage device. Yet, in other aspects, the test electrochemical energy storage device present in the disclosed modules can have the temperature sensor that is positioned in a center of the internal compartment of the test electrochemical energy storage device.

In still further aspects, the test electrochemical energy storage device and/or the high thermal conductivity surrogate heater element are inserted into an insulating shell. It is understood that any insulating materials can be used. In certain exemplary and unlimiting aspects, the insulating shell can comprise calcium silicate. In still further aspects, the module disclosed herein can be positioned in a compartment, wherein the compartment is a gas flow-through compartment. In such aspects, the gas flow-through compartment is configured to keep the module in a steady state. Without wishing to be bound by any theory, it is assumed that the steady state of the module provides test conditions where a gas heat convection coefficient is known and can be used for calculations. In still further aspects, the compartment can further comprise at least one barrier, thus creating at least two separate sub-compartments, wherein a first sub-compartment comprises the test electrochemical energy storage device and a second sub-compartment comprises the high thermal conductivity surrogate heater element, and wherein the first and the second sub-compartments are thermally isolated from each other.

In still further aspects, the gas can be any gas under the desired conditions and whose thermal behavior is known. For example and without limitations, the gas can comprise air, nitrogen, argon, and the like, or any combination thereof. In still further aspects, the thermal behavior of the high thermal conductivity surrogate heater element is known.

The thermal sensors and the heating devices present in the test electrochemical energy storage devices of the disclosed modules can be any of the disclosed above sensors and heating devices.

In yet still further aspects, the control unit is configured to process one or more heating temperature data, power-temperature data, or power-time data to develop a power function representative of the thermal power of the test electrochemical energy storage device.

Also disclosed are aspects with a module comprising a) a test electrochemical energy storage device having has an internal compartment and an external surface, wherein the internal compartment comprises: i) a negative electrode; ii) a positive electrode; iii) a temperature sensor; and iv) a heating device; wherein the temperature sensor and the heating device are positioned within at least a portion of the internal compartment of the at least one test electrochemical energy storage device; and b) a control unit that is in electrical communication with the test electrochemical energy storage device and that is configured to independently heat the internal compartment and the external surface of the test electrochemical energy storage device to a first temperature and a second temperature respectively, and wherein the control unit is further configured to collect and process data to analyze the thermal behavior of the test electrochemical energy storage device. In such aspects, the module does not comprise a high thermal conductivity surrogate heater element. The test electrochemical energy device used in such modules can be any one of the disclosed above test electrochemical energy devices.

In still further aspects, this additional module can also be placed in a compartment similar to one disclosed above. It is understood that the at least one barrier is optional, especially if only one test electrochemical energy storage device is present.

### Methods

Further disclosed herein are methods comprising: a) providing at least one test electrochemical energy storage having an internal compartment and an external surface, wherein the internal compartment comprises: i) a negative electrode; ii) a positive electrode; iii) a temperature sensor; and iv) a heating device; wherein the temperature sensor and heating device are positioned within at least a portion of the internal compartment of the at least one test electrochemical energy storage device, and b) heating the at least one test electrochemical energy storage device to cause an internal failure.

Any of the disclosed above the at least one test electrochemical energy storage device can be utilized in the described methods.

In still further aspects, the step of heating comprises bringing the internal compartment of the at least one test electrochemical energy storage device to a first predetermined temperature by heating the heating device. In such aspects, the first predetermined temperature is from about 60° C. to about 1,500° C., including exemplary values of about 100° C., about 150° C., about 200° C., about 250° C., about 300° C., about 350° C., about 400° C., about 450° C., about 500° C., about 550° C., about 600° C., about 650° C., about 700° C., about 750° C., about 800° C., about 850° C., about 900° C., about 950° C., about 1,000° C., about 1,050° C., about 1,100° C., about 1,150° C., about 1,200° C., 1,250° C., about 1,300° C., about 1,350° C., about 1,400° C., and about 1,450° C.

In still further aspects, the method further comprises measuring one or more of thermal properties, reactive/kinetic properties, a degradation path, and/or stability of active materials in the at least one test electrochemical energy storage device.

Yet, in still further aspects, the method further comprises a step of modeling one or more of thermal properties, reactive/kinetic properties, a degradation path, and/or stability of active materials of one or more electrochemical energy storage devices that are substantially identical to the at least one test electrochemical energy storage device with the absence of at least the heating device and/or the temperature sensor.

Also disclosed herein are aspects wherein the at least one test electrochemical energy storage device is formed by inserting the temperature sensor and the heating device into at least a portion of an internal compartment of one or more electrochemical energy storage devices. Some exemplary methods of making the at least one test electrochemical energy storage device are shown in the Examples.

In some aspects, the at least one test electrochemical energy storage device is fully discharged to a predetermined voltage prior to the insertion of the temperature sensor and the heating device.

In still further aspects, the methods disclosed herein further comprise heating the external surface of the at least one test electrochemical energy storage device to a second predetermined temperature wherein the first and the second predetermined temperatures are the same or different.

In yet other aspects, the methods disclosed herein can provide for calorimetric properties of the at least one test electrochemical energy storage device.

In still further aspects, the electrical properties of the one or more electrochemical energy storage devices before insertion of the heating device and the temperature sensor are substantially identical to the electrical properties of the at least one test electrochemical energy storage device.

In the methods disclosed herein, the at least one test electrochemical energy storage device is in electrical communication with a control unit. The methods further comprise independently heating a surrogate cell heater element that is in electrical communication with the at least one test electrochemical energy storage device to measure calorimetric properties of the at least one test electrochemical energy storage device.

In the disclosed methods, the at least one test electrochemical energy storage device and the surrogate cell heater element are configured to be heated independently to a first temperature and a second temperature, respectively. In some aspects, the first and the second temperatures are the same, while in other aspects, the first and the second temperatures are different.

In certain aspects, the methods disclosed herein can further comprise inserting the at least one test electrochemical energy storage device into a pack comprising the one or more electrochemical energy storage devices. In such aspects, the thermal behavior of other electrochemical energy storage devices in the pack can be evaluated. In such exemplary aspects, the step of heating would cause a thermal runaway failure of the one or more electrochemical energy storage devices in the pack.

The aspects disclosed herein provide a method for closing the power balance on the test device by measurement of the heat losses on the surrogate heater. In alternative aspects, the heat loss can be determined without the need for a surrogate heater by a heat loss model.

Also disclosed herein is a method for analyzing the thermal behavior of any of the disclosed herein test electrochemical energy storage devices. Such methods can comprise: a) heating the internal compartment to a temperature; b) equilibrating a temperature of the external surface of the test electrochemical energy storage device with the temperature of the internal compartment; c) heating a high thermal conductivity surrogate heater element to match the temperature of the external surface of test electrochemical energy storage device; d) continue heating the internal compartment until a thermal runaway of the test electrochemical energy storage device is initiated; e) heating a surface of the high thermal conductivity surrogate heater element to match a temperature up to a predetermined value of the test electrochemical energy storage device; and f) estimating the thermal behavior of the test electrochemical energy storage device.

In such aspects, the predetermined value can be about 400° C., about 500° C., about 600° C., about 700° C., about 800° C., about 900° C., or about 1,000° C. In still further aspects, the predetermined value can be up to about 400° C., up to about 500° C., up to about 600° C., up to about 700° C., or up to about 800° C.

It is understood that in some aspects, the heating of the internal compartment to the desired temperature can be continuous. Yet, in other aspects, the heating of the internal compartment to the desired temperature can be a “step and hold” heating, which can be repeated until the thermal runaway is initiated.

In certain aspects, the method can further comprise measuring a power of the high thermal conductivity surrogate heater element during the heating step c).

In yet other aspects, when the thermal runaway of the test electrochemical energy storage device is initiated, the heating of the internal compartment is stopped.

In still further aspects, the step of the estimating comprises using a thermal model that could be in an analytical form, computational form, or data-driven form, with known physical and thermal properties (mass, density, volume, area, heat capacity, thermal conductivity, etc.), and calibrated electrochemical parameters (pre-exponential factor and activation energy) to establish the thermal behavior of the test electrochemical energy storage device given specified test conditions.

In still further aspects, the disclosed methods can comprise steps wherein the module is positioned in a gas flow-through compartment. In such aspects, the compartment can further comprise at least one barrier, thus creating at least two separate sub-compartments, wherein a first sub-compartment comprises the test electrochemical energy storage device and a second sub-compartment comprises the high thermal conductivity surrogate heater element, and wherein the first and the second sub-compartments are thermally isolated from each other. In still further aspects, the gas is supplied at a predetermined flow rate. In yet still further aspects, the gas is supplied to the first and the second sub-compartment at a substantially same predetermined flow rate. It is understood that any of the gases disclosed above can be utilized.

Yet additional methods of analyzing the thermal behavior of the disclosed herein test electrochemical energy storage devices are also disclosed. In such aspects, the module comprises any of the disclosed herein test electrochemical energy storage devices but does not comprise any of the disclosed above high thermal conductivity surrogate heater elements. In such aspects, the methods can comprise a) heating the internal compartment to a temperature; b) heating the external surface of the test electrochemical energy storage device to match the temperature of the internal compartment of the test electrochemical energy storage device; c) continue heating the internal compartment until a thermal runaway of the test electrochemical energy storage device is initiated; and d) estimating the thermal behavior of the test electrochemical energy storage device.

Similar to the other methods disclosed herein, the heating of the internal compartment to the desired temperature can be continuous or be a “step and hold” heating which is repeated until the thermal runaway is initiated.

It is also understood that in any methods described herein, the compartment as disclosed above can be utilized to keep the modules in a steady state. It is understood that the at least one barrier is optional, especially if only one test electrochemical energy storage device is present.

In still further aspects, the method further comprises measuring a power of a heater used to heat the external surface of the test electrochemical energy storage device. In yet further aspects, when the thermal runaway of the test electrochemical energy storage device is initiated, the heating of the internal compartment is stopped. In yet still further aspects, the step of the estimating comprises using a thermal model in an analytical or computational form, with known physical and thermal properties (mass, density, volume, area, heat capacity, thermal conductivity, etc.), and calibrated electrochemical parameters (pre-exponential factor and activation energy) to establish the thermal behavior of the test electrochemical energy storage device given specified test conditions.

By way of a non-limiting illustration, examples of certain aspects of the present disclosure are given below.

### EXAMPLES

The following examples are put forth so as to provide those of ordinary skill in the art with a complete disclosure and description of how the compounds, compositions, articles, devices, and/or methods claimed herein are made and evaluated and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is degrees C. or is at ambient temperature, and pressure is at or near atmospheric.

In these examples, the development of the internal failure approach involved: cell modification, cycling, and on-site testing. For easy access, the experimental preparations involved are designed to be easily reproducible with standard lab equipment and affordable materials. The cell modification primarily involves inserting a mini-heater cartridge inside a 18650 using accessible materials and machining processes.

To prove that the battery performance had not been altered as a result of the modification, the modified cells were verified through cycling, and their voltage and capacity profiles were compared to those of the same cells prior to modification. A modified cell was placed in a customized thermal venting characterization system (called failure tube) as described below to test the thermal and electrical behavior of internally failed cells. To check repeatability among the modified cells, the failure tube tests were conducted on each cell, and the temperature profiles (internal and surface temperatures) were collected for different conditions.

The disclosed below experiments also serve the purpose of demonstrating the thermal runaway kinetics of modified cells, which are compared to those of unmodified cells. Also, as disclosed below, to test the implementation of the modified cell in a large battery system, a 18650 powered electronic package was used to simulate a single battery's internal failure in an enclosure.

In general, the ISC technique is a process to create an instrumented battery/cell that can be reliably triggered to fail using an internal heater system. Present technologies such as nail penetration use a nail to mechanically penetrate a cell to induce an internal short circuit; the phase-change-material (PCM) approach uses a wax sandwiched between anode and cathode that, when melted, produces an internal short circuit; the shape-memory-alloy (SMA) approach uses an SMA that bends at a particular temperature to penetrate the separator to induce ISC; dendrite-growth (DG) approaches use implanted ion particles in the cathode that triggers ISC during cycling.

Overall, the objective of this disclosure is to create an easily configured, repeatable, and controllable method to simulate realistic internal failures in cylindrical cells for battery safety system designers and manufacturers to test and examine the performance of the designed protective mechanisms in said systems in order to enhance battery safety.

### Example 1

### Modification of a Commercially Available 18650 Lithium-Ion Cell

Lithium-ion batteries studied in this paper and modified for the internal failure tests are commercially available Samsung INR18650-25R cells having a LiNiₓMn_{y}CO_{z}O₂ (Li-ion with Nickel/Manganese Cobalt Oxide Cathode (“NMC”)) chemistry that has a nominal voltage, capacity, and rating of about 3.6 V, about 2.5 Ah, and about 9.0 W-h, respectively. Since all of the Samsung INR18650-25R cells were commercially procured, exact details pertaining to the particular subcategory of NMC cathode chemistry (electrolyte compositions, mass splits of cell components, etc.) are not available. However, without wishing to be bound by any theory, based on scanning electron microscopy and energy-dispersive x-ray spectroscopy (SEM/EDS), and x-ray diffraction (XRD) analysis, the NMC composition was hypothesized to be Ni_{0.8}Mn_{0.1}Co_{0.1} based. 18650 NMC 811 is considered to be a state-of-the-art battery technology due to the high energy density from the cathode. While NMC 811 was already available several years ago, it was only implemented in cylindrical cells and reported in the literature in recent years, therefore making 18650 NMC 811 a relatively novel and uncommon cell. Modification of the cell was made with a few materials and equipment: thermal paste, syringe, epoxy, type K thermocouples, and a mini-heater cartridge. To modify the cell, first, an 18650 was cycled by charging to about 4.2 V and discharging to a cutoff voltage of about 2.5 V three times to obtain its voltage and capacity profiles and examine its state-of-health (SOH). Next, it was fully discharged to about 2.5 V to deplete the charge for safety.

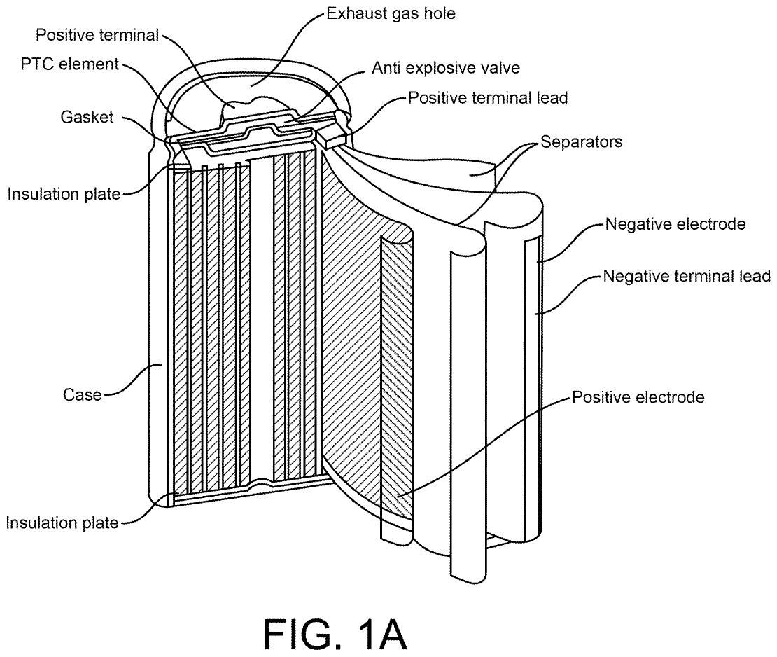

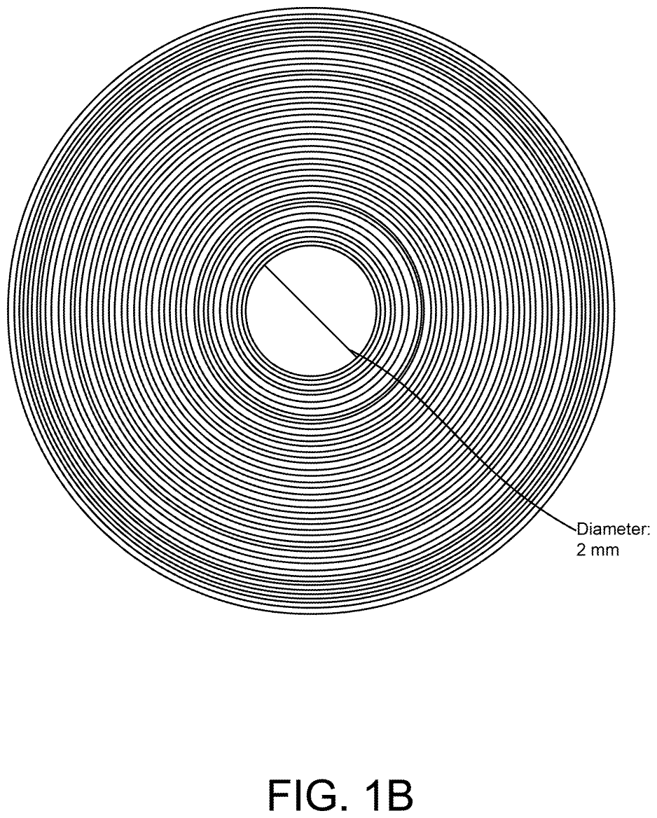

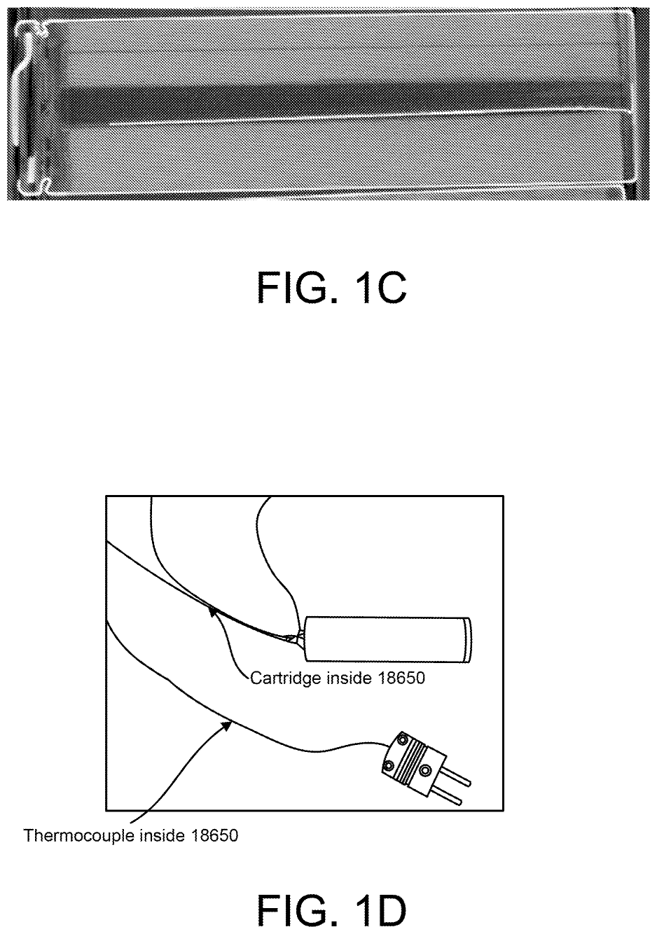

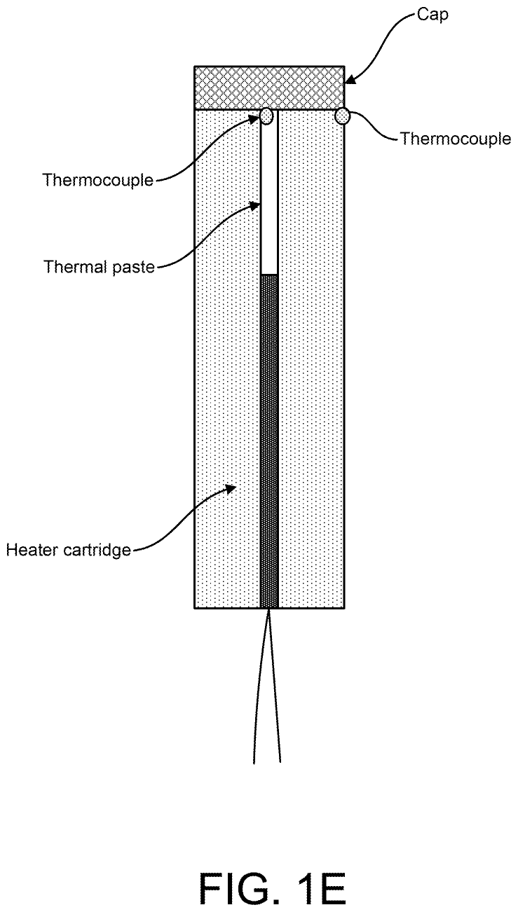

The general schematic and the photographs of the Samsung INR18650-25R cell are shown in FIGS. 1A-1C. The center of the cell on the bottom face was marked and placed under the drill press. Because Samsung INR18650-25R does not have a mandrel, the center of the jelly roll is hollow and is approximately 2.5 mm in diameter (FIGS. 1B-1C). The hollow center allows drilling through the bottom center with a 3/32 inch (2.38 mm) diameter drill bit without damaging the jelly roll. The thermocouple was then inserted into the formed opening against the bottom of the cap to measure and represent the center temperature. A moderate amount of thermal paste (ARCTIC MX-4) was squeezed into the cell via a syringe to fill up the hollow space at the center. A 2-mm diameter, 40-mm long 12V mini-heater cartridge rated for 12 W was inserted into the cell, leaving only the heater wires (and thermocouple) outside the cell, as shown in FIGS. 1D-1E.

Without wishing to be bound by any theory, it was hypothesized that the paste helps establish more intimate contact between the heater cartridge and the jelly roll and thus improves the heat transfer. Epoxy (JB-weld) was used to seal the bottom hole. The cell was cured for about 24 hours for stabilization, thus completing the modification.

In certain aspects, the thermal paste can be replaced with any other known conductive material. For example, and without limitation, an aluminum slug can replace the thermal paste. The slug can have an outer diameter that is the same as the heater diameter (e.g., 2 mm). In certain aspects, the slug can be drilled halfway through its length at its center with a 1-mm drill bit. Without wishing to be bound by any theory, it is hypothesized that the half-hollowed-out section allows the accommodation and stabilization of a temperature-measuring sensor or other temperature-measurement sensor. It is further assumed that because aluminum has a high thermal conductivity, its temperature will be relatively uniform. The aluminum temperature measured by the sensor can be used to represent the center temperature of the cylindrical cell.

If the cell voltage monitoring of the test cell is desired, the modification of the conventional cell can also include a spot welding of two pieces of nickel strip to the top and bottom of the cell before applying the epoxy. The voltage is collected with alligator clips with wires attached to the nickel strips. The epoxy is then applied to cover the nickel strips. Upon completing the modification, the cell was cycled again for safety and performance checks.

### Failure Tube Test Setup and Procedures

A failure tube was used to induce thermal runaway in a controlled environment. The setup included structural components, sensors, and gas supplies. The structural components include a tube, flow meter, diffuser, clamps, connectors, and tubing. Diverse types of sensors are included in the apparatus for measuring temperature (i.e., thermocouples), oxygen concentration (i.e., oxygen sensor), and heat flux (i.e., directional flame thermometer (DFT)).

Gas supplies come from nitrogen or air cylinders, depending on the desired oxygen concentration inside the tube. The details of the setup and components can be found in Yan et al. (“Towards fire forensic characteristics of failed cylindrical format lithium-ion cells and batteries, “Journal of Fire Technology (2021)), the content of which is incorporated herein in its whole entirety. In the external heating tests, a single 18650 was supported and stabilized by a routing clamp at the center of the tube. The cell is coiled in a 36-inch and 125-Watt Nickel alloy heater wire, and the wire is held together with aluminum tape. A thermocouple is inserted between the cell and the heater wire to measure the cell's surface temperature. In some external heating tests, the temperature in the center of the cell was collected by drilling about a 1.59-mm hole through the bottom of the cell and inserting a thermocouple inside the cell, similar to what is shown in FIG. 1E. Furthermore, in some external heating tests, battery voltage was monitored by welding Nickel tabs onto positive and negative terminals of the cell, clipping alligator clips onto the tabs, and connecting the alligator clip wires to the data acquisition system.

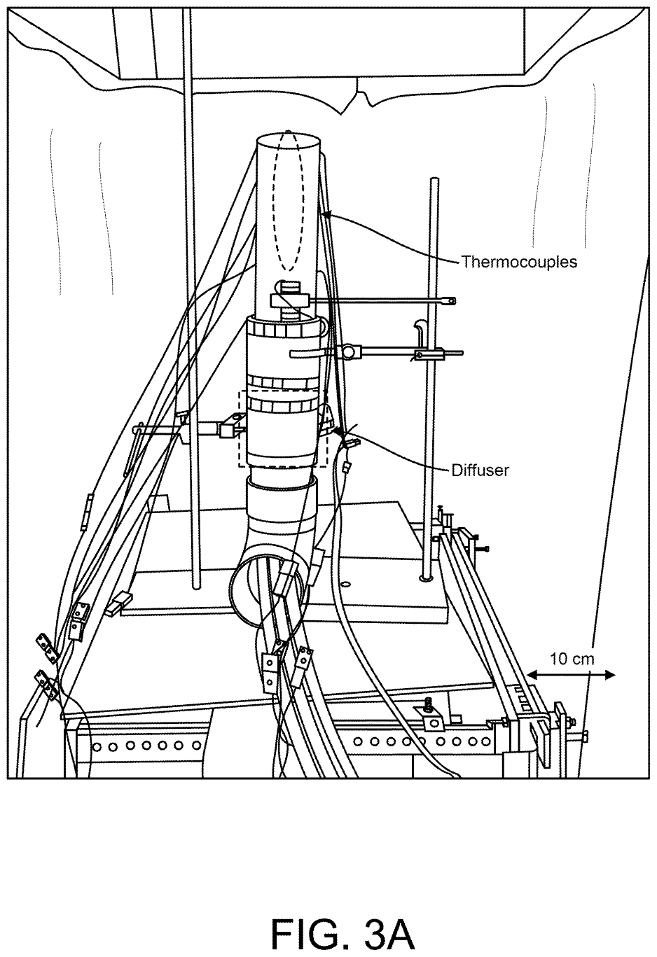

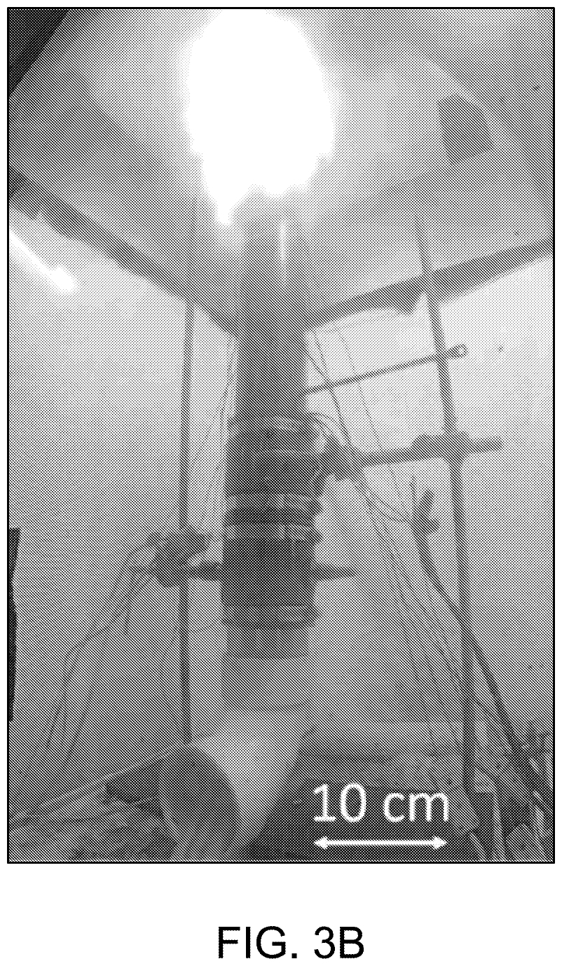

In the internal heating tests, a single modified 18650 cell was also stabilized at the center of the tube in an analogous manner as in the external heating tests. The modified cell was wrapped inside the kaowool for insulation to minimize heat loss from the inserted heater. In all internal heating tests, a thermocouple was inserted between the cell and kaowool insulation to measure the cell's surface temperature, and the thermocouple inside the cell was used to measure the center temperature. Overall, the external and internal heating tests inside the failure tube were set up in a comparable manner, as shown in FIGS. 3A-3B. All thermocouples and voltage wires were connected to the data acquisition system for temperature and voltage measurements. The 125-watt heater wire in the external heating test was connected to a wall outlet, while the 12-watt heater wire in the internal heating test was connected to a DC power supply set at 12 V and 1 A.

All failure tube tests were set up under the canopy hood to evacuate the gases during thermal runaway. To perform the failure tube test, an air/inert test environment was set up by flowing air/nitrogen through the tube, and the flow rate was also set to about 57 liters per minute (or 2 cfm). In the inert environment, two minutes after the nitrogen flow was introduced, the oxygen concentration inside the tube dropped from about 21% to about 0.03% based on an oxygen sensor placed inside the tube. Since the nitrogen was kept flowing through the tube, the internal oxygen concentration was considered steady, and the tube was considered to be sufficiently inert. The test began by starting the temperature recordings at a sampling rate of 0.1 s for one minute. Gas cylinder was turned to supply air/nitrogen for two minutes. Next, the power supply (wall outlet or DC power supply) was turned on to activate the heater. As the 18650 cell was heated up, the center and surface temperatures of the cell and ambient temperatures inside the tube started to increase. After some time, the cell went into thermal runaway, and all temperatures peaked. Afterward, everything cooled down to room temperature. The temperature profile was used to track important stages of the test. The failure tube test was conducted multiple times for 100% SOC cells for repeatability test. It was also performed for different SOCs of cells (about 70%, about 50%, and about 30%).

### Mass Loss Test Setup and Procedures

The mass loss test provides crucial gravimetric information on the battery gas release by measuring the mass loss over the course of the battery's failure. It has a relatively simple setup: an aluminum holder, a 18650 cell, and an electronic scale. The aluminum holder was machined from a 50.8×50.8×152.4 mm (2×2×6 in) aluminum block.

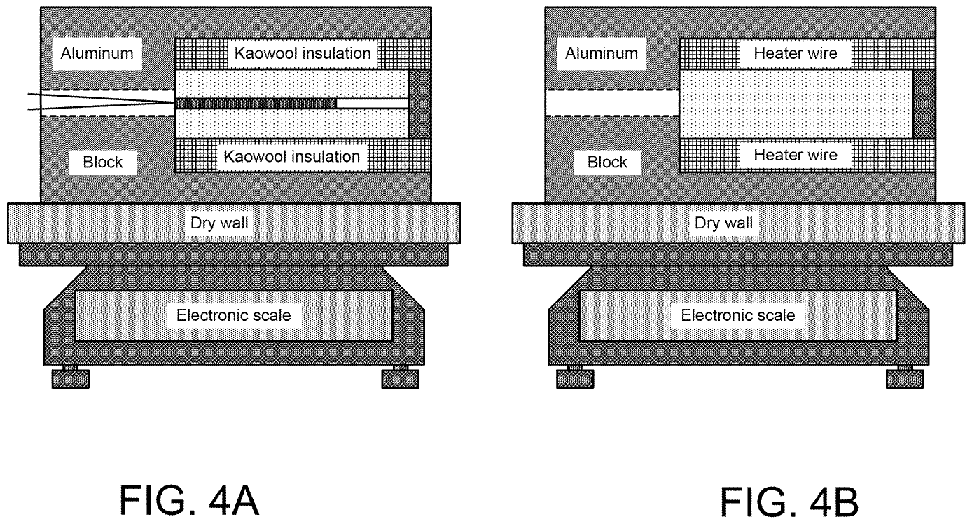

A 33 mm (1.3-inch) diameter hole was drilled from one end to the center to accommodate the cell wrapped in ceramic fiber, as shown in FIG. 4. The cell was positioned horizontally inside the holder because a vertically positioned cell releases an upward venting or flame jetting during thermal runaway, which would exert a downward reaction force towards the scale and distort the actual mass change data. By placing the cell horizontally, the vertical component of the force exerted from venting or jetting can be alleviated, thus providing a more accurate assessment of the mass loss from the gas release.

A 6.35 mm (¼ inch) diameter hole was drilled from the center to the other side of the block to create a pathway for thermocouples and heater wires to come out of and connect to the external Graphtec data acquisition system and DC power supply, respectively. The aluminum holder with the modified cell was then placed on top of an electronic scale connected to a laptop to which the mass loss data was saved. The cell inside the aluminum holder was heated sufficiently to go into thermal runaway. Depending on the SOC of the cell, it would experience either vapor outgassing at low SOCs (30%, 50%) or hot products jetting at high SOCs (70%, 100%). After the cell thermal runaway event, no more gases or other products were ejected from the cell, and the mass data became steady, thus concluding the test.

The test was also conducted using the external failure technique for the same SOCs of cells to compare how different failure mechanisms would result in different failure behaviors in terms of mass loss. During a typical mass loss test, the mass measurement was mostly steady (constant or slowly decreasing) prior to the thermal runaway event. When thermal runaway occurs, the exiting jet flow initiates vibrations in the surrounding objects (aluminum box and thermocouples) on the scale, thus imparting noise to the mass readings. Recording time-resolved mass variation during a thermal runaway event is challenging, and an alternative approach was used. Since the thermal runaway duration was short, the mass loss rate was assumed constant and linearly interpolated between the initial and final mass. The overall mass loss was determined by subtracting the final mass from the initial mass. The schematic of the internal and external heating to determine the mass loss is shown in FIGS. 4A-4B.

### Laptop Test Setup and Procedures

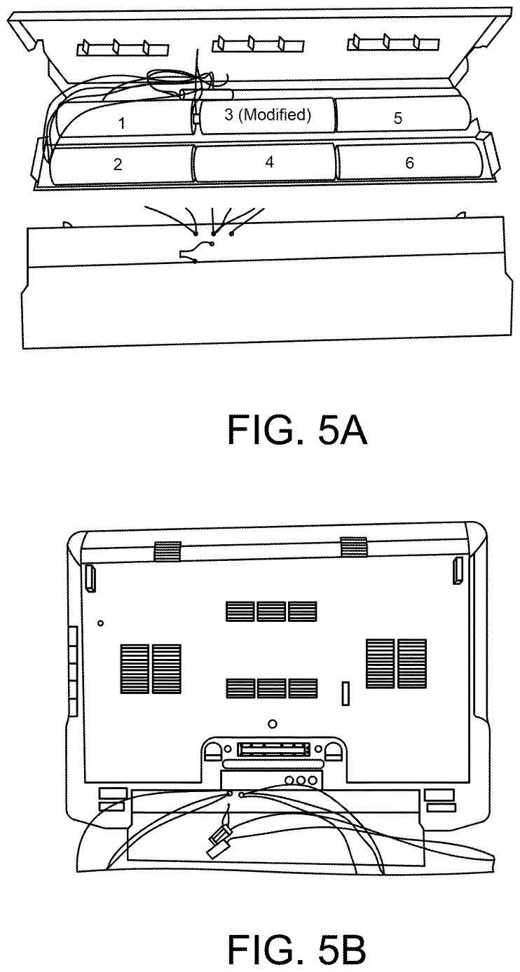

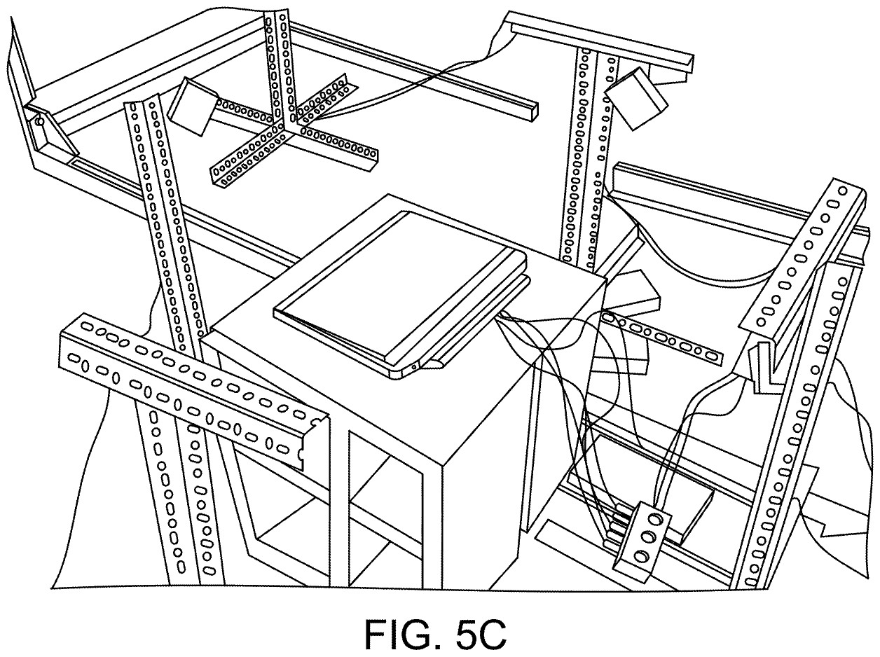

Laptop tests were conducted to examine the implementation of a modified cell into a common commercial battery package and trigger it into failure within said package. The modified cell was inserted into the power bank of the laptop, and the laptop's performance was measured. The conducted tests aimed to determine whether the modified cell can be adopted into power systems to induce on-demand failures. In the selected laptop, the cell arrangement was 3 by 2 for E6220's power bank. One of the six 18650 batteries in the power bank was substituted with a modified cell, as shown in FIG. 5A. To be consistent, all the cells in the power banks were replaced with Samsung INR18650-25R cells. Seven thermocouples were used in the setup, with six of them attached to the surface of the six cells and one inserted in the center of the modified cell to collect temperature profiles during the test.

Holes were drilled into the power bank such that all the thermocouples and the heater wires could be extended to the external Graphtec devices and DC power supply (FIG. 5B). The laptop was centered between four directional flame thermometers (DFTs). DFTs are commonly used to measure heat flux in fire experiments. Each DFT was positioned approximately 36 cm away and about 41 cm above the laptop. Cameras were placed around the laptop to record the tests from different angles (FIG. 5C). The test was initiated by turning on the heater inside the modified cell. After a period of heating, the modified cell went into thermal runaway.

Previous tests have suggested that thermal runaway propagation depends on the initiation location. Hence, the failure of the modified cell may not cascade to all the cells. Because there was no way to visually observe the cells inside the power bank, their temperatures were used to confirm their state. Because the failure mechanism (overheating) used in the laptop tests was similar to that used in the failure tube tests, and the cell surface temperature at the onset of its thermal runaway was typically between about 250° C. and about 300° C., the surface temperature was used as the signature of battery failure. When the surface temperature exceeded about 300° C., the cell was considered to have gone into thermal runaway. Therefore, sufficient time was dedicated to the laptop tests for any possible thermal runaway of cells to occur. The test could only be concluded after all temperatures inside the power bank dropped below about 100° C. This way, one can ensure that either the cell had already gone into thermal runaway or it would not be able to. The temperature recording was then stopped and collected to examine the thermal impact of a single cell failure on the power bank.

### Example 2

### Performance Check of the Modified 18650 Cell

After a 18650 cell was modified, a cycling test was done on the cell before and after modification for safety and performance checks. This test was conducted to ensure that the internal structural modification from drilling, heater insertion, and epoxy sealing did not lead to performance issues or varying SOH within the cell. The before-and-after voltage and capacity profiles were compared. These profiles were used to determine whether voltage or capacity faded due to the modification procedure observed. In such cases, the voltage would behave abnormally during the cycling test and deviate from its normal profile.

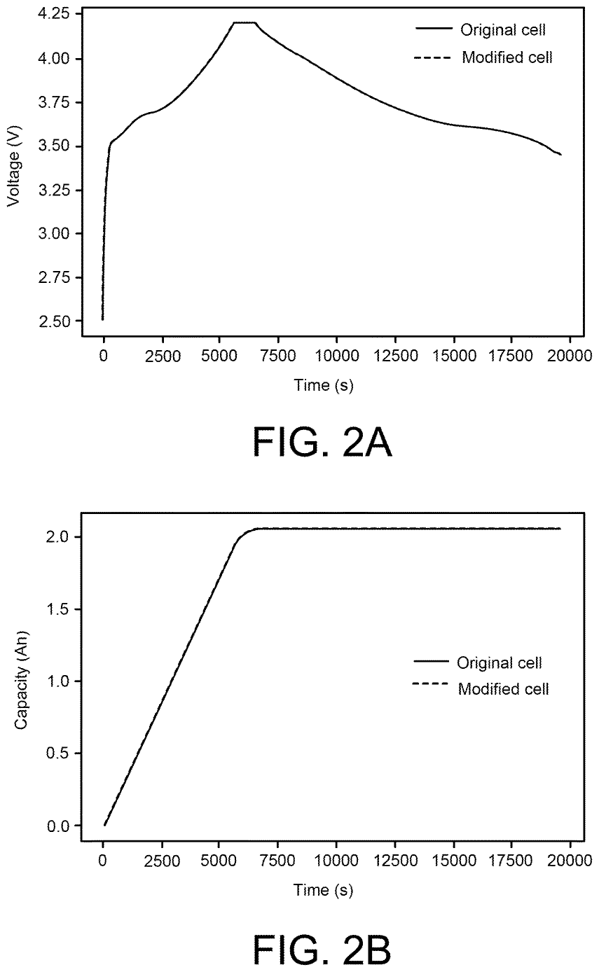

Capacity profile was also used to examine the battery's SOH. The SOH is quantitatively defined as the ratio of the battery's maximum charge capacity to its rated maximum charge capacity. The batteries used in these experiments were rated at about 2.5 Ah (Note that experiment measurements indicate approximately 2.55 Ah) charge capacity. If a battery deteriorates due to the modification, the maximum charge/discharge capacity that it can receive/provide will decrease, hence showing up on the capacity profile. In addition, internal damage to the cell could also cause the cell to self-discharge, resulting in a measurable voltage drop over time. Hence, a voltage check after the cycling tests directly examines the cell's quality. As shown in FIGS. 2A-2B, the overlapping voltage and capacity profiles show that the modified cell did not deviate from its as-received conditions. Open circuit voltage was measured for each modified cell after a 24-hour rest, and no appreciable self-discharge was observed. Overall, the quality and performance of the majority of the modified cells were not altered by the modification procedures based on the cycling test results and observations over time. It was found that about 5% of the modified cells (1 out of about 20) experienced self-discharge due to their own fault and not as a result of the modification procedure. The rest of the modified cells were considered acceptable for the failure tube tests and other experiments.

### Repeatability Tests of the Modified 18650 Cell

When a modified cell was ready for testing, failure tube tests were conducted to examine its failure repeatability and compare its thermal characteristics of thermal runaway to those of an externally heated unmodified cell. In the failure tube test within an inert/air environment, temperature profiles were collected for external and internal heating tests to identify four major stages: Heating, venting, thermal runaway, and cooling/resting. The details of the kinetics of the four stages for the external heating case have been explored explicitly in Yan et al.'s as referenced above.

TABLE 1
Test conditions for failure tube test

| Test Type | % SOC | No. of test | Power, W |
|---|---|---|---|
| External heating | 0 | 1 | 20 |
| External heating | 0 | 1 | 125 |
| External heating | 30 | 1 | 125 |
| External heating | 50 | 1 | 125 |
| External heating | 70 | 1 | 125 |
| External heating | 100 | 5 | 125 |
| Internal heating | 0 | 1 | 12 |
| Internal heating | 30 | 1 | 12 |
| Internal heating | 50 | 1 | 12 |
| Internal heating | 70 | 1 | 12 |
| Internal heating | 100 | 5 | 12 |

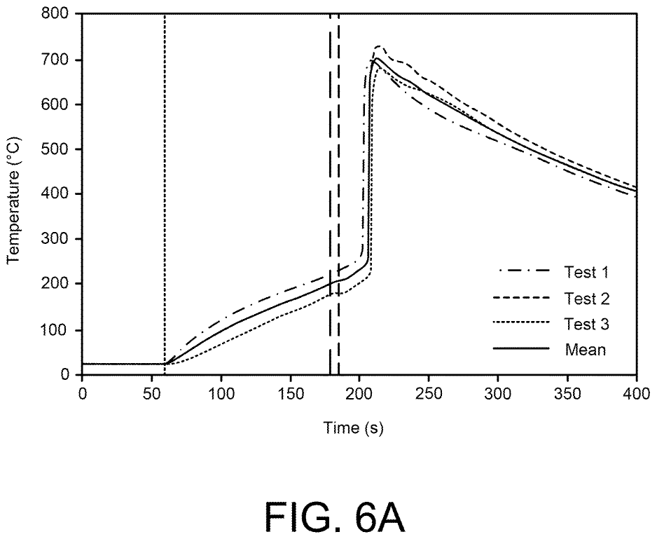

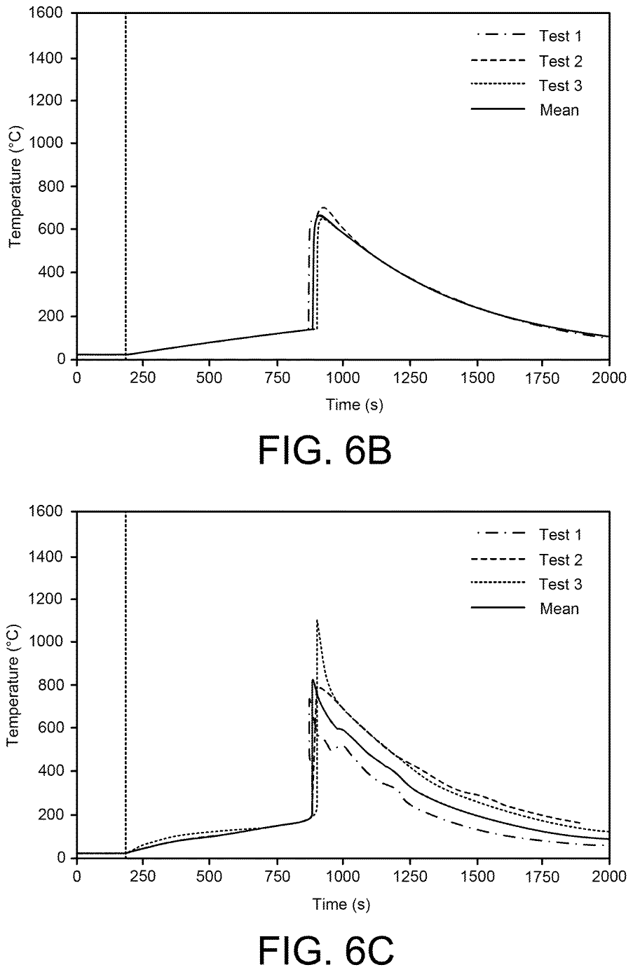

Without wishing to be bound by any theory, it is assumed that as the cell is heated up during the heating stage, the internal reactions generate gases and build up internal pressure. Eventually, a critical pressure threshold is reached, and the vent opens and releases the gases. At some point during venting, a gas jet is released, and sparks from the vent orifice ignite the gases to start a chain of combustion events. The cascading reaction process is called thermal runaway and normally lasts for a few seconds. After the thermal runaway ends and internally generated gases vent, the heater is turned off within 5 seconds after the thermal runaway for the cell to cool down, and all four stages are completed. The failure tube internal heating tests for 100% SOC cells were examined under similar test configurations to those of the external heating tests, and the results for both are shown in FIGS. 6A-6C. In general, both external and internal heating tests have demonstrated good repeatability during the heating and venting stages. The external heating tests show an approximately 1.39° C./s heating rate during the heating stage, while the internal heating tests show a heating rate of approximately 0.22° C./s at the center and about 0.17° C./s on the surface during the heating stage. The difference in the heating rates is primarily due to their heating powers (125 W for the external heating vs. 12 W for the internal heating). The vent opening times from the external heating tests range from about 179 to about 184 seconds, as shown in FIG. 6A, vertical dashed lines mark the heater turning on (about 60 s for external heating and about 180 s for internal heating) and vent openings (Test 1: 179.2 s; Test 2: 184.5 s; Test 3: 184.7 s).

Although both tests exhibit acceptable repeatability, there is less scatter in the internal test temperature profiles (FIGS. 6B-6C), mainly due to the fact that heat loss in the internal heating tests was minimized by having the heater located inside the cell. In contrast, the heater was wrapped around the cell surface and not insulated for the external heating tests. The peak surface temperatures from the external heating tests range from about 581.6 to about 785.1° C. For the internal heating tests, the peak surface temperatures range from about 626.9 to about 719.7° C., and the peak center temperatures range from about 735.3 to about 1366.9° C. Since the peak surface temperatures in both heating cases are similar to each other, it suggests that the surface temperature of a 100% SOC cell during a thermal runaway is mainly dominated by its own heat generation and less dominated by the heater power output from these tests. Therefore, the peak surface temperature is not sensitive to the heat methodologies considered in this paper.

On the other hand, collecting the center temperatures has proven to be challenging in some tests where the inner thermocouple was broken during the intense thermal runaway event, resulting in incomplete center temperature data. Also, some center temperature data from thermal runaway were extremely noisy and were hence removed from the plot. Despite the fluctuation in the peak measurements, the center temperatures can be observed to exceed the surface temperatures, as one would expect due to the internal heat generation processes. In general, the center temperatures during thermal runaway were shown to range from about 1000 to about 1400° C. (thermocouples in this study are rated for about 1400° C. max), significantly hotter than the surface. Despite the good repeatability during heating, the onset times of thermal runaway are not as repeatable in both cases, which might be attributed to the different inherent physical properties of cells. Overall, the failure tube internal heating tests demonstrated reasonable consistency in the temperature data, which allows for better confidence in the experimental measurements and analysis using the current setup.

### Characterization of 18650 Cells Failure Under Various Configurations

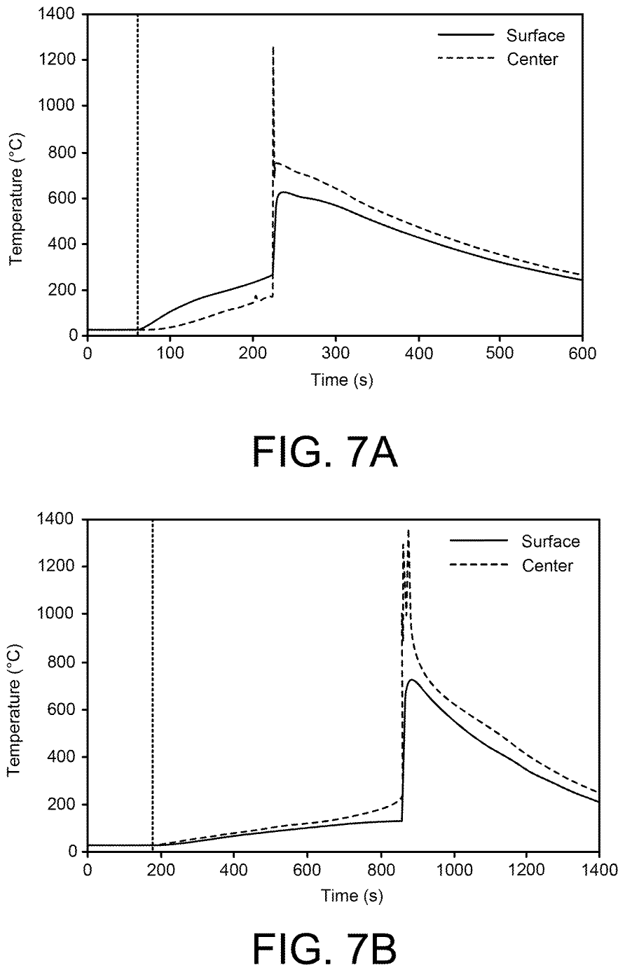

After assessing reproducibility, further failure tube tests were conducted to compare the differences between external and internal heating failures. FIGS. 7A-7B show a time evolution of the surface and center temperature profiles of a 100% SOC cell in the external (FIG. 7A) and internal (FIG. 7B) heating tests. The heater was turned on at about 60 and about 180 seconds for the external and internal heating tests, respectively. In the external heating test, the center temperature increases at a higher rate than the surface temperature initially due to external heating. In the internal heating test, the center temperature increases at a slightly higher rate than the surface temperature due to internal heating. When thermal runaway occurs, the center temperature from internally and externally heated cells rapidly exceeds the surface temperature due to internal heat generation. Also, the peak surface and center temperatures from the two different heating methodologies are similar to each other; thus, the intensity of the thermal runaway is not affected by the modification.

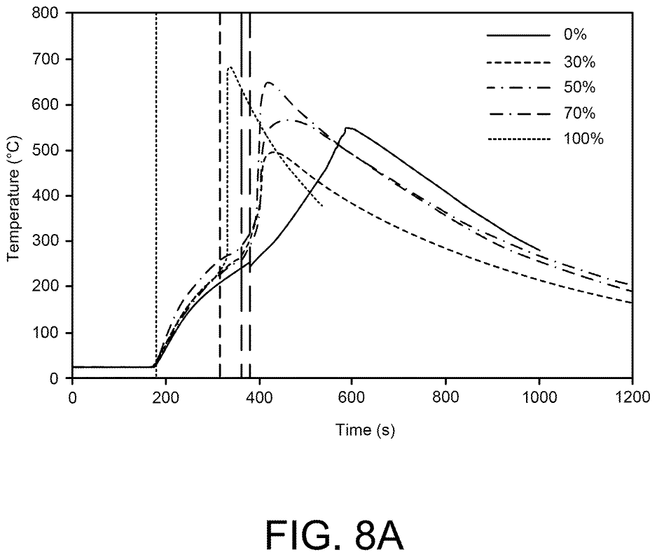

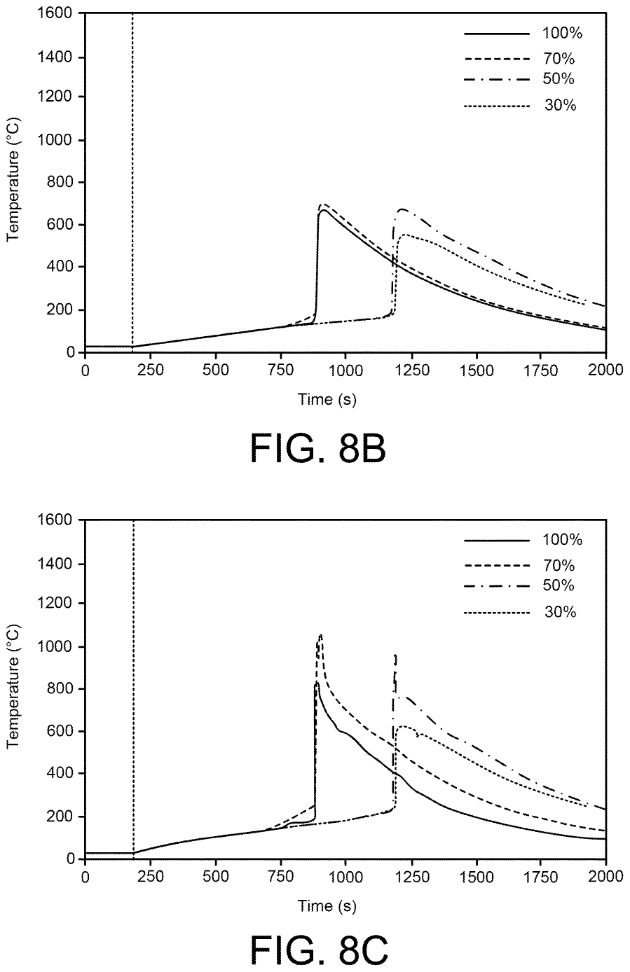

Additional external and internal heating tests were conducted at varying SOCs. FIG. 8A shows the time evolution of surface temperature profiles of cells of varying SOCs in the external heating tests, and the bottom figures show the time evolution of surface and center temperature profiles of cells of varying SOCs in the internal heating tests; vertical dashed lines mark the heater turning on (180 s) and vent openings (100%: 314.3 s; 70%: 360.1 s; 50%: 362.5 s; 30%: 360.2 s; 0%: 380.3 s). In both external and internal heating tests, FIGS. 8A-8C show that the peak surface temperatures generally decrease with decreasing SOCs due to lower energy density. It is also shown that the vent opening times generally decrease with increasing SOCs in both heating tests. The vent opening times from the external heating tests range from about 314.3 to about 380.3 seconds between 100% and 0% SOC cells, respectively. Without wishing to be bound by any theory, it was hypothesized that the delayed vent openings were partially due to the reduced intercalated lithium and electrolyte solvent decomposition reactions at the anode side. In the external heating tests, heating rates above 30% SOC (1.39° C./s) are noticeably higher than that at 0% SOC (1.13° C./s).

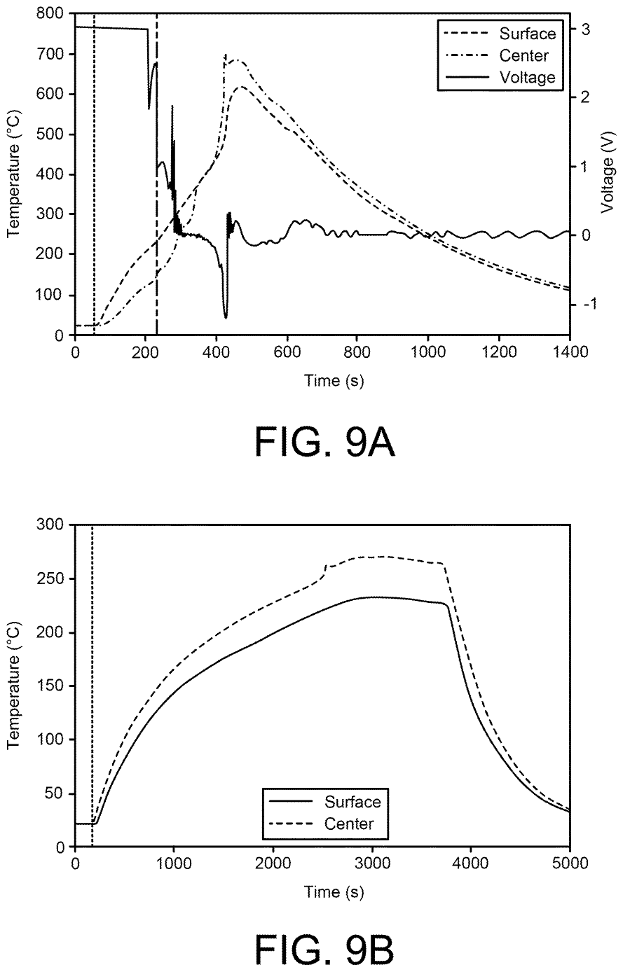

The decrease in the heating rate at 0% SOC was found to result from reduced internal heat generation. Without wishing to be bound by any theory, it was assumed that a fully discharged cell does not have intense exothermic chemical reactions prior to thermal runaway. However, it was further assumed that it can still go into thermal runaway if heated to a sufficiently high initiation temperature and reach a peak temperature of above about 500° C. In this case, the thermal runaway was observed to be in the form of outgassing vapor, similar to that of 30% and 50% SOC cells. More results with fully discharged cells in the external and internal heating tests are shown in FIGS. 9A-9B; vertical dashed line marks the vent opening (232 s). The center temperature profile in the external heating test shows multiple increases in temperature rate. The center temperature was lower than the surface temperature at the start. It caught up to the surface temperature at about 350 seconds and surpassed the surface temperature after about 400 seconds, which suggests the occurrence of some amount of exothermic chemical reactions.

On the other hand, the center temperature profile from the internal heating test also shows an increase in the rate of temperature rise at nearly 2500 seconds. However, the modified cell did not vent or show any other jetting behavior for the duration of the test. There was no indication of a thermal runaway because the cell eventually reached a steady-state temperature distribution.

Again, without wishing to be bound by any theory, it was hypothesized that thermal runaway did not occur because the temperature was not sufficiently high to induce cathode breakdown reactions. Previous works show that the cathode breakdown temperature of about 312° C. for 0% SOC may need to be necessary for a thermal runaway to happen. These assumptions were supported by the 0% SOC external heating test that had shown that before thermal runaway at about 400 seconds, there was a rapid temperature increase when the center temperature was about 300° C. These results have suggested that the 0% SOC cell needs to reach such a high temperature to trigger exothermic reactions in order to initiate thermal runaway.

The cell from the internal heating test reached a steady state due to insufficient heating power and thus could not vent or go into thermal runaway. Although a cell is considered depleted at 0% SOC, from a fire safety perspective, the 600-700° C. peak temperatures show that even a 0% SOC cell's thermal runaway can still present serious risks of damaging/igniting adjacent materials.

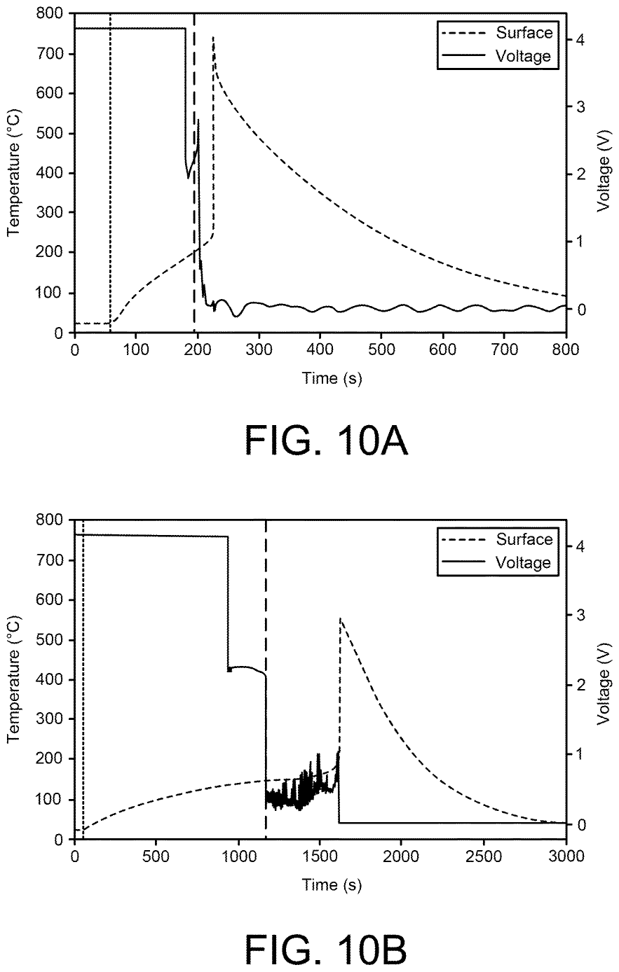

In contrast to the existing ISC approaches introduced earlier, the heater-insertion technique uses a heater cartridge to internally heat up the cell (jelly roll and electrolyte). The increase in the internal cell temperature initiates the SEI decomposition and electrochemical reactions at the anode between intercalated lithium and electrolyte. In addition, as the temperature increases, the separator fails, causing an internal short circuit and generating heat. As discussed earlier, the drop in measured voltage seen in the voltage trace is likely due to the loss of lithium ions at the anode and separator failure. For externally heated cells, the voltage first drops at a surface temperature of about 180° C. However, due to internal heat transfer resistances and thermal capacitance, the surface temperature is not a good indicator of the internal temperatures required for exothermic reactions. Based on FIG. 8A, the center temperature for the externally heated cell at the time of voltage drop is estimated to be about 100° C., and thus, the temperatures across the jelly roll are between about 100° C. and about 180° C. Approximately 20 seconds after the voltage drops, the cell vents at a surface temperature of approximately 200° C., as shown in FIGS. 10A-10B, where the center temperature is estimated to be about 120° C.

At the onset of thermal runaway, the externally heated cell has a center temperature of about 167° C. and a surface temperature of about 260° C., which suggests, without wishing to be bound by any theory, that the internal short circuit is initiated near the exterior side of the jelly roll. Because cathode breakdown reactions occur at a higher internal temperature than anode reactions and generate oxygen which can react with electrolyte and intercalated lithium, it is hypothesized that the high energy release rate reactions (and rapid increase in temperature) at the center of the cell are indicative of the cathode breakdown process.

In contrast, for internally heated cells, the voltage first starts dropping slowly at a center temperature of approximately 100° C., likely due to anode reactions. At a center temperature of about 160° C., it was observed that the voltage dropped drastically, possibly due to separator failure. As the internally heated cell reaches a center temperature of approximately 185° C. and a surface temperature of approximately 136° C., the cell starts to vent and is immediately preceded by a fast temperature rise rate, which suggests that the internal short circuit and subsequent reactions are initiated near the interior side of the jelly roll. The time between the vent opening and thermal runaway is significantly shorter in internally heated cells compared to externally heated cells.

Without wishing to be bound by any theory, it was assumed that the time difference between the vent opening and the high cell temperature rise rate in the external and internal heatings can be because the rate of anode reactions is proportional to the anode surface area. In the internal heating tests, heat is concentrated near the center where the anode reactions occur. In the interior of the jelly roll, the anode surface area is smaller per unit width of the jelly roll than the exterior, and the power generated by the anode reactions is relatively lower. In the external heating tests, on the other hand, heat is concentrated on the perimeter of the cell. Because the anode surface area is much larger on the outer perimeter, more anode reactions happen, and more gases are generated. Hence, after a temperature increase of about 20° C. since the start of anode reactions (which begin at about 100° C.), the externally heated cells are able to generate sufficient gases to vent before the cathode breakdown begins at approximately 160° C., whereas a temperature increase of about 60° C. is needed for the internally heated cells to generate enough gases to vent, just before the cathode breakdown. Still further, without wishing to be bound by any theory, it was hypothesized that the reaction kinetics within the jelly roll can be important.

The internally heated cell has a heating area of approximately 250 mm². In the PCM ISC approach, the copper puck used as the contact between the current collectors has an area of about 8 mm² (3.18 mm diameter). In the nail penetration test, the nail used for cell penetration is 3.8 mm in diameter and 50 mm long. In the SMA ISC approach, the alloy used for puncturing the separator is 7.5×7.5 mm. Overall, the mechanisms used by these other conventional ISC approaches to trigger an internal short circuit are relatively small in size. Thus, one can expect that the internal short circuit area is also localized. On the other hand, in this disclosure, the internally heated cell has a relatively larger heated surface area, which suggests a larger internal short circuit area. Although the short-circuit-affected zones differ between the existing techniques and the heater-insertion technique used in the current study, they all seem to successfully initiate thermal runaway through their respective triggering mechanisms.

Furthermore, in cases where a cell is required to fail, the technique introduced in this study has a fail-safe advantage due to consistent heating. For instance, a cell discharges rapidly due to an internal short circuit, and if the discharging process is not able to produce sufficient heating to initiate thermal runaway, the cell will simply not go into thermal runaway due to energy depletion (which is why inducing thermal runaway of a single cell by the external short circuit is extremely challenging due to heat losses). In general, the success of thermal runaway initiation by the existing techniques depends on having the internal short circuit produce enough heat, which may not be repeatable for numerous reasons. On the other hand, the heater-insertion technique always allows the heater to consistently initiate thermal runaway. Therefore, the heating mechanism by the heater-insertion technique is a more reliable approach for triggering thermal runaway.

Based on visual observations of the experiments, it is also found that cells experienced the venting stage differently between the external and internal heating tests. The externally heated cell is typically vented for at least about 20 seconds before thermal runaway. However, the internally heated cell went through the venting stage much more quickly (less than a second) before the thermal runaway. To quantitatively represent vent opening, voltage measurements are used because the CID activation (vent opening) breaks the circuit and leads to a rapid or sudden voltage drop. FIGS. 10A-10B show the time evolution of surface temperature and voltage profiles of 100% SOC under high power (125 W; FIG. 10A) and low power (20 W; FIG. 10B) heating in external heating tests; vertical dashed lines mark the heater turning on (60 s) and vent openings (125 W: 195.6 s; 20 W: 1168.7 s). It can be observed that both cells experienced a noticeable voltage drop once during the heating stage and once at the vent opening.

It should be noted that the cells studied in this disclosure do not have a positive temperature coefficient (PTC) inside, and thus the voltage drop is mainly affected by internal kinetics. Without wishing to be bound by any theory, and as shown in previous reports, voltage drop during the heating stage can be attributed to the breakdown of the thin passivating SEI layer on the anode; short-circuit between the anode and cathode as the separator shrinks; and loss of lithium-ion at anode and loss of active material at the cathode. Voltage drop at the vent opening is due to circuit breakage. The second voltage drop can also be associated with a vent opening event during external heating tests, as shown in FIGS. 9A-9B and 10A-10B.

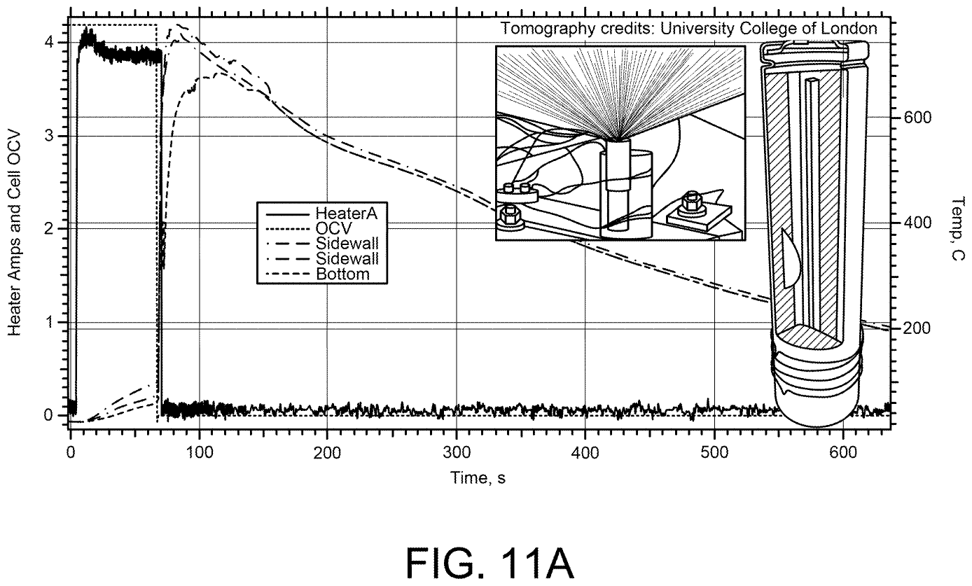

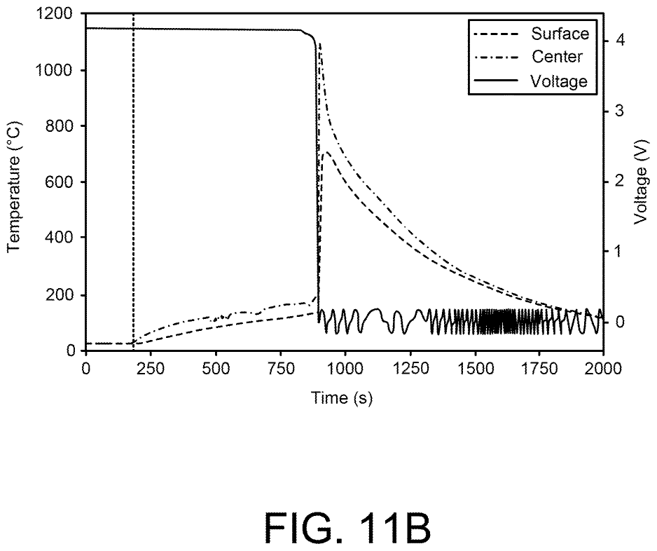

FIGS. 11A-11B show the time evolution of voltage and temperature profiles of a 100% SOC 18650 cell failed by conventional PCM ISC developed by NREL/NASA (FIG. 11A) and a modified cell (FIG. 11B) failed in an internal heating test; vertical dashed line marks the heater turning on (180 s). Only one drastic voltage drop is observed in both results and is clearly caused by the vent opening, as it is immediately preceded by a thermal runaway. Without wishing to be bound by any theory, this distinction in venting and thermal runaway behaviors was thought to be caused by low heating but was disproved by the low-power external heating test in FIGS. 10A-10B.

However, if the internal heating method is representative of some of the “real-world” battery failures which behave differently than the traditional external heating failures, then it is in the interest of battery forensics research to explore this methodology more and adapt it to represent those special cases. Overall, the heater-insertion technique is easily accessible with standard lab equipment and materials and reliably induces realistic thermal runaway behavior in an on-demand manner. Other known technologies, such as nail penetration, have poor repeatability; PCM and SMA approaches have complex experimental preparation; the DG approach has poor controllability.

### Modified 18650 SOC and Mass Loss

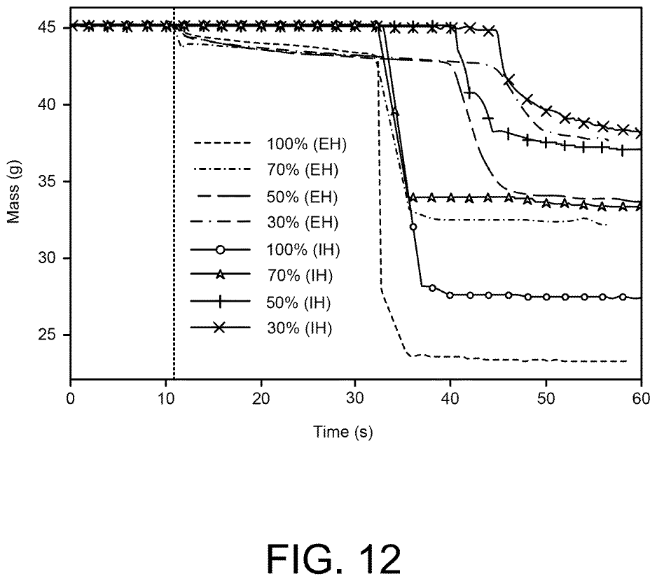

The mass loss of a 18650 cell after thermal runaway was found to be proportional to its SOC in previous reports. Conditions for mass loss in the test described herein are shown in Table 2. However, since the externally and internally heated cells experienced venting and thermal runaway events differently, it is of interest to learn how mass loss differs for externally and internally heated cells. The time evolution of mass profiles for external and internal heating tests is presented in FIG. 12; vertical dashed line marks the vent opening. When the vent opens for the externally heated cells, there is rapid mass loss at an average rate of approximately 2 g/s over approximately one second. After that, the mass-loss rate slowed down to an average value of approximately 0.05 g/s during venting. After this venting condition that lasts for about 20-30 seconds, another high mass-loss rate event occurs due to thermal runaway. Furthermore, the mass-loss rates during the venting of externally heated cells appear to be almost identical to each other. Since the mass loss rate depends on the internal pressure and orifice area, without wishing to be bound by any theory, it was suggested that the gas generation rate during the vapor venting stage prior to thermal runaway is close between about 30 and 100% SOC cells, which leads to similar pressure drops across the orifice and gas flow rates.

Despite having a similar mass-loss rate during the vapor venting stage before thermal runaway, the overall mass loss after thermal runaway has shown to be proportional to the SOC. The internally heated cells' venting occurred just before thermal runaway, and thus very little mass loss was observed prior to that, which is consistent with the observations from the failure tube tests. The results in Table 3 show that cells from the external heating tests experienced similar mass loss as the internal heating tests except at 100% SOC, which may be due to the significant loss of vented electrolyte vapor during the venting stage prior to thermal runaway. Hence, mass loss can be affected by the failure mechanism. Gravimetric tests require the context of the failure mechanism in order to effectively deduce a cell's SOC prior to failure.

### Example of Use of Modified 18650 Cell in Laptop Failure Test

Cycling and failure tube tests have shown that the modified 18650 cell can be reliably induced into thermal runaway, and the results are comparable to cells that failed with other existing ISC approaches. Hence, the next step was to implement the modified cell into a larger battery system (i.e., laptops) to simulate a single-cell failure inside a power package. It is of interest to investigate single-cell failure propagation to other cells in the battery pack.

To set up the test, a laptop power bank was reconstructed to contain one modified cell among other pristine cells. The modified cell would then be triggered to thermal runaway and create cascading damage to the laptop. It has been demonstrated in Yan et al. experiments that battery failure inside a laptop power bank can lead to cascading failures among other cells in the bank. Here, a 18650 surrogate heater was used to externally heat up the adjacent cells until thermal runaway occurred in the first cell and propagated through the rest in the package. The test was able to simulate a scenario where a laptop is heated and ignited by an external heat source. However, the surrogate heater conducted lots of heat to its vicinity, thermally affecting multiple cells and the package. By the time the first thermal runaway was initiated, other adjacent cells had been heated to above about 100° C. Hence, it is limited to scenarios where multiple cells are thermally compromised. On the other hand, preheating the modified cell occurs inside. This way, one can examine how the thermal effects of one failing cell on the adjacent cells prior to its thermal runaway differ.

TABLE 2
Conditions for mass loss tests

| Test Type | % SOC | Power, W |
|---|---|---|
| External heating | 30 | 125 |
| External heating | 50 | 125 |
| External heating | 70 | 125 |
| External heating | 100 | 125 |
| Internal heating | 30 | 12 |
| Internal heating | 50 | 12 |
| Internal heating | 70 | 12 |
| Internal heating | 100 | 12 |

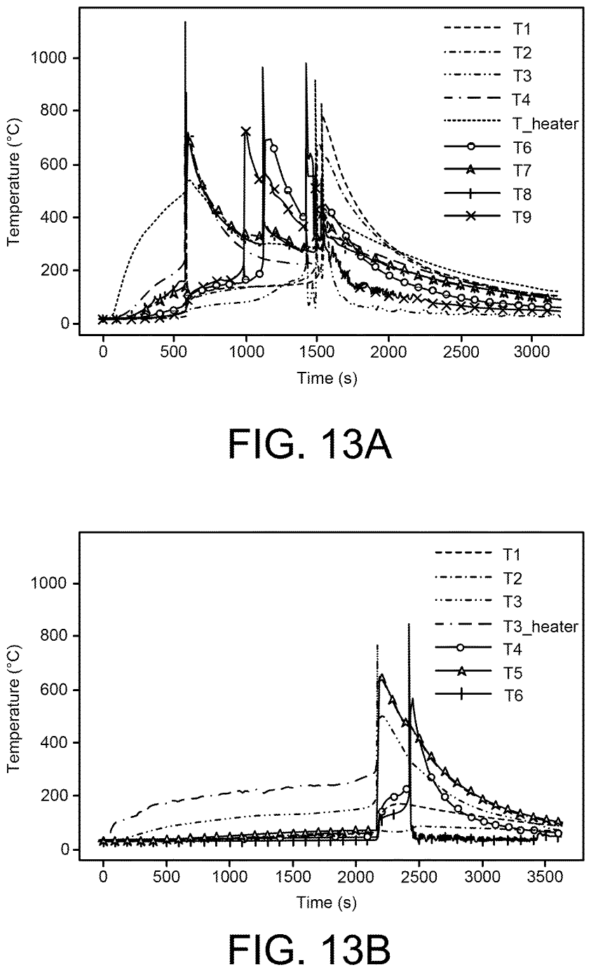

More specifically, once a modified cell is placed inside the power package, it is induced intoathermal runaway in the same manner as was performed in the failure tube tests. The results show that the modified cell can be triggered to fail inside the power bank. FIG. 13B shows temperature traces for the laptop failure test induced by the modified 18650 cell. Cell 3 (FIG. 5A) was the modified cell, and as it was heated up, the heat transfer from the modified cell to other cells was relatively low. By the time it went to thermal runaway, other cells had only been heated to about 50-60° C., which is within an acceptable range for the battery's normal operation. Contrast this with a test in which the thermal runaway was triggered by the 18650 surrogate heater. Cells next to the heater have been heated to well above about 100° C. by the time the first thermal runaway occurred, as shown in FIG. 13A. In the previous studies, nine cells were involved in the test, and three sets of failures occurred. The surrogate cell (i.e., heater initially heated up cells 4, 7, and 8) and these failed earliest. At a slightly later time (after approximately 540 seconds) cells 9 and 6 failed. Finally, failures were observed in cells 1, 2, and 3. The effect of the relatively large surrogate cell heating power (125 W) caused significant preheating that accelerated the cell failure process.

To achieve a more realistic scenario where only one cell causes the failure, thereby affecting the rest of the cells, the modified 18650 cell setup is more desirable. It is also noteworthy that not all cells went into a thermal runaway in this setup, as cells 1 and 2 were mostly unaffected. This is due to the directional property of the hot-vented gases released from the cap of the failed cells. As shown in FIG. 5A, the caps of the cells were pointing to cells 5 and 6. Therefore, when cell 3 went into thermal runaway, most of the energy was transferred toward cells 5 and 6 through the hot-vented gases. On the other hand, the impact on cells 1 and 2 in the opposite direction was minimized. This shows that the position of the failure influences failure propagation within the power package. Overall, the implementation of the modified cell into a commercial electronic device, in this case, a laptop, is a straightforward process that can simulate a single-cell failure-induced fire incident in a practical and realistic manner. Due to the modification procedures, the current ISC heater-insertion technique is limited to cylindrical cells. Different ISC techniques for other cell formats (pouch, prismatic, etc.) may be explored in the future.

TABLE 3
Test results for mass loss tests

| Test Type | SOC | Test 1 (g) | Test 1 (g) | Test 1 (g) | Mean (g) |
|---|---|---|---|---|---|
| External heating | 100 | 21.8 | 22.2 | 21.3 | 21.8 |
| External heating | 70 | 11.4 | 10.3 | 10.3 | 10.7 |
| External heating | 50 | 7.1 | 7.4 | 7.5 | 7.3 |
| External heating | 30 | 7 | 6.9 | 6.5 | 6.8 |
| Internal heating | 100 | 17.9 | 17.7 | 16.7 | 17.4 |
| Internal heating | 70 | 11.4 | 12.8 | 13.1 | 12.4 |
| Internal heating | 50 | 8.8 | 8.6 | 8.9 | 8.8 |
| Internal heating | 30 | 6.6 | 6.4 | 6.6 | 6.5 |

### Example 3

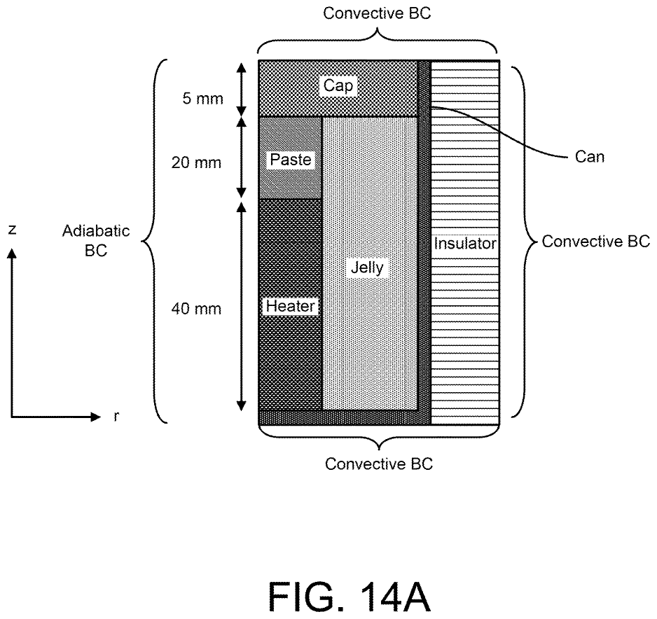

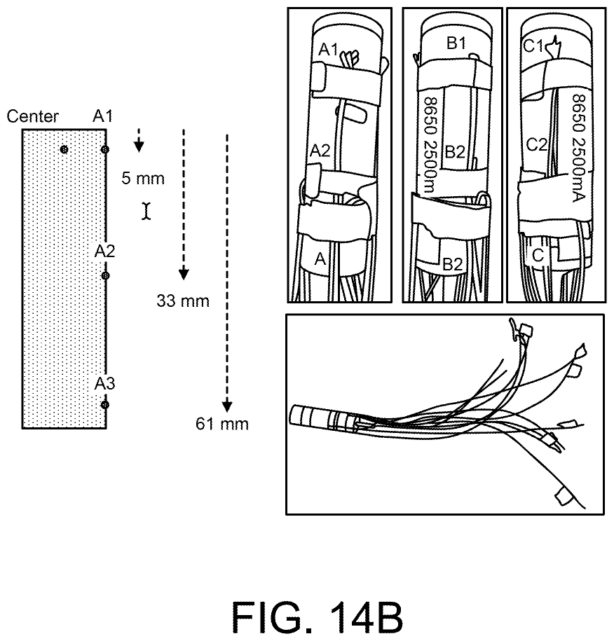

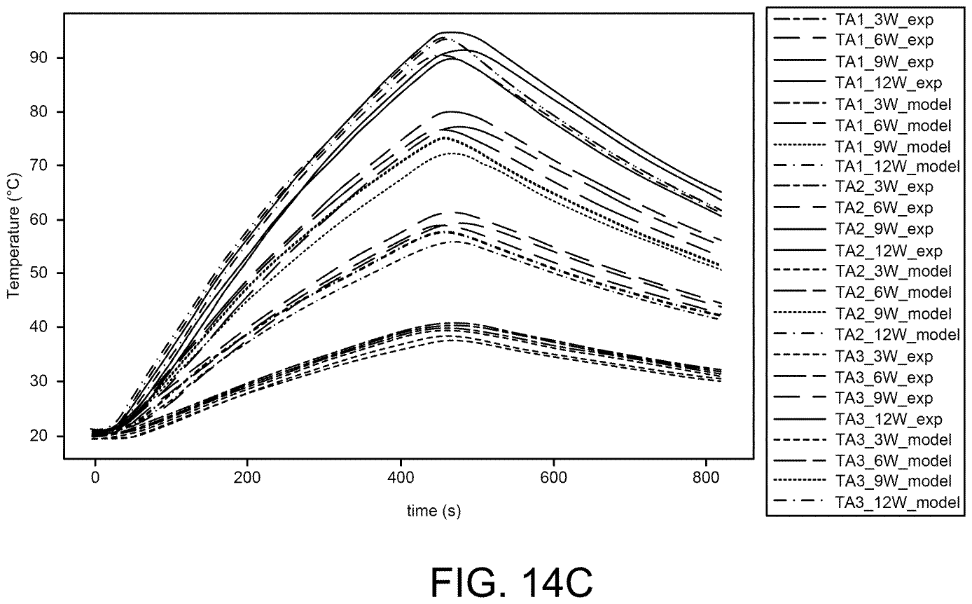

In this example, thermal modeling of 0% SOC cell was performed. The schematic of the model is shown in FIG. 14A. Temperatures were measured at various points of the test device, as shown in FIG. 14B and the thermal properties inferred from the model and measured temperatures are shown in FIG. 14C.

The 2D thermal model uses a backwards Euler method, known physical and thermal properties (mass, density, volume, area, heat capacity, thermal conductivity, etc.), and calibrated electrochemical parameters (pre-exponential factor and activation energy). The model is generally governed by the radial and axial heat conduction equation:

$$\frac{\partial T}{\partial t} = α ( \frac{1}{r} \frac{\partial T}{\partial r} + \frac{{\partial }^{2} T}{\partial {r}^{2}} + \frac{{\partial }^{2} T}{\partial {z}^{2}} )$$

In the heater element area where heat is generated from the resistor, it is governed by the following:

$$\frac{\partial T}{\partial t} = α ( \frac{1}{r} \frac{\partial T}{\partial r} + \frac{{\partial }^{2} T}{\partial {r}^{2}} + \frac{{\partial }^{2} T}{\partial {z}^{2}} ) + \frac{\dot{Q}}{{mc}_{p}}$$

In the jelly roll area where heat is generated from the electrochemical reactions, it is governed by:

$$\frac{\partial T}{\partial t} = α ( \frac{1}{r} \frac{\partial T}{\partial r} + \frac{{\partial }^{2} T}{\partial {r}^{2}} + \frac{{\partial }^{2} T}{\partial {z}^{2}} ) + \frac{\sum {A}_{i} exp ( \frac{- {E}_{a , i}}{RT} )}{{mc}_{p}}$$

The model is bounded by adiabatic conditions at the cell center and convective conditions at the outer perimeter. The spatial derivatives are calculated using second-order-centered differencing schemes, and the temporal derivatives are calculated using the backwards Euler method because it is universally stable. By computing the spatial temperature variation across the device at each time step, the model is able to establish the thermal behavior of the test electrochemical energy storage device given the specified test conditions.

### Example 4

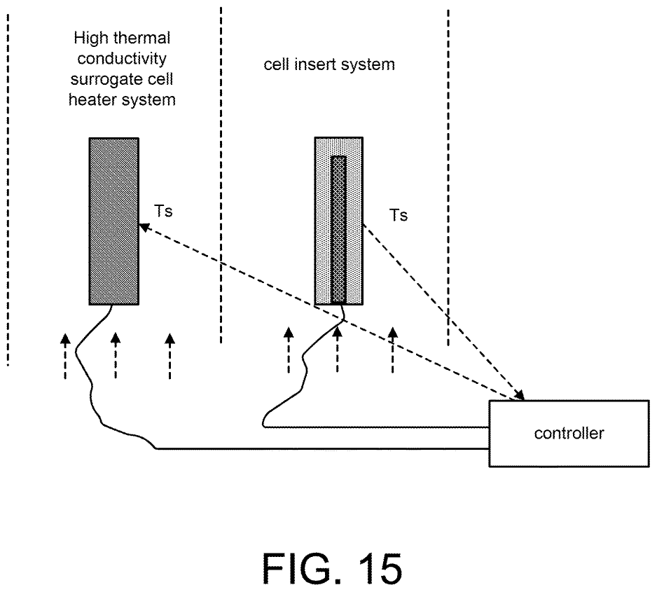

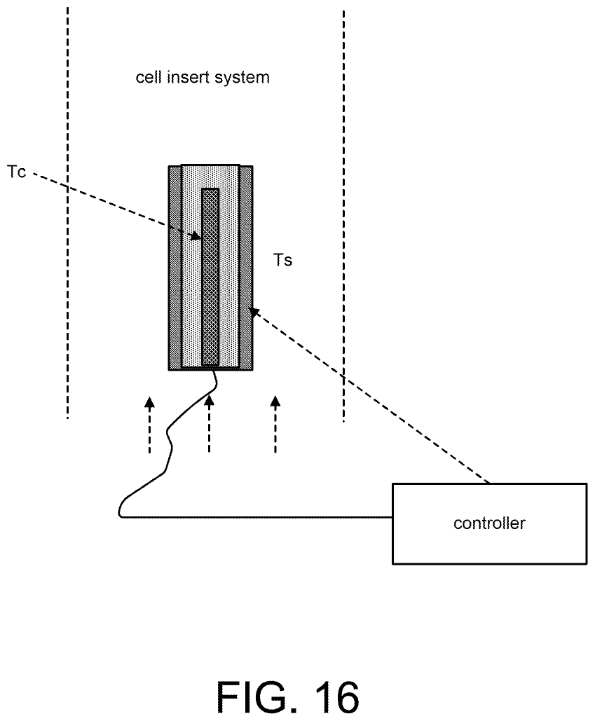

In this example, various modules for real-time thermal behavior analysis of a test electrochemical energy storage device are described and shown in FIGS. 15 and 16. For example, FIG. 15 shows an exemplary and not limiting module comprising a test electrochemical energy storage device and a high thermal conductivity surrogate heater element connected with a control unit. The flow and thermal configurations in the test electrochemical energy storage device and surrogate are identical. The power into the surrogate heater has been specified to yield the same surface temperature as the test electrochemical energy storage device. The power in the surrogate heater is measured using the heater's electrical measurements. The electrochemical power generated in the test energy storage device is calculated using the power input into the internal heater, the thermal model for the test energy storage device, and the energy losses from the device as determined by the surrogate. The thermal models that can be used range from a full three-dimensional solution of the heat equation with parameterized energy generation terms to thermal models.

FIG. 16 shows a different exemplary and not limiting module that does not involve an additional surrogate heater element but is entirely focused on temperature differences within the internal compartment of the test device and its external surface. For a case in which a surrogate heater element is not used, the power balance on the test energy storage device uses a heat loss model for the heat lost from the test energy storage device to close the power balance. The model could be a data-driven model, an analytical model, or a computational model. The electrochemical power generated in the test energy storage device is calculated using the power input into the internal heater, the thermal model for the test energy storage device, and the energy losses from the device as determined by the heat loss model.

### Example 5

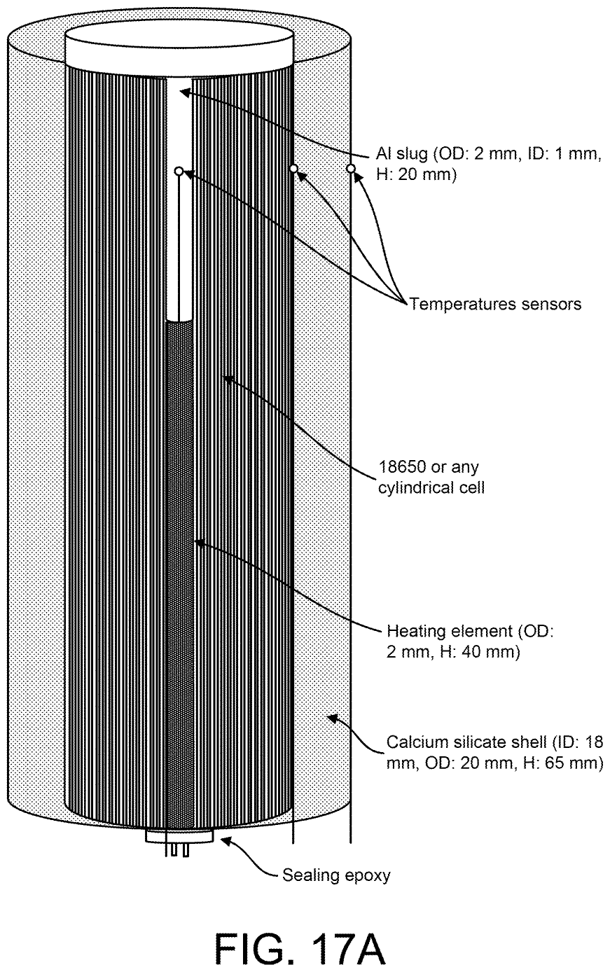

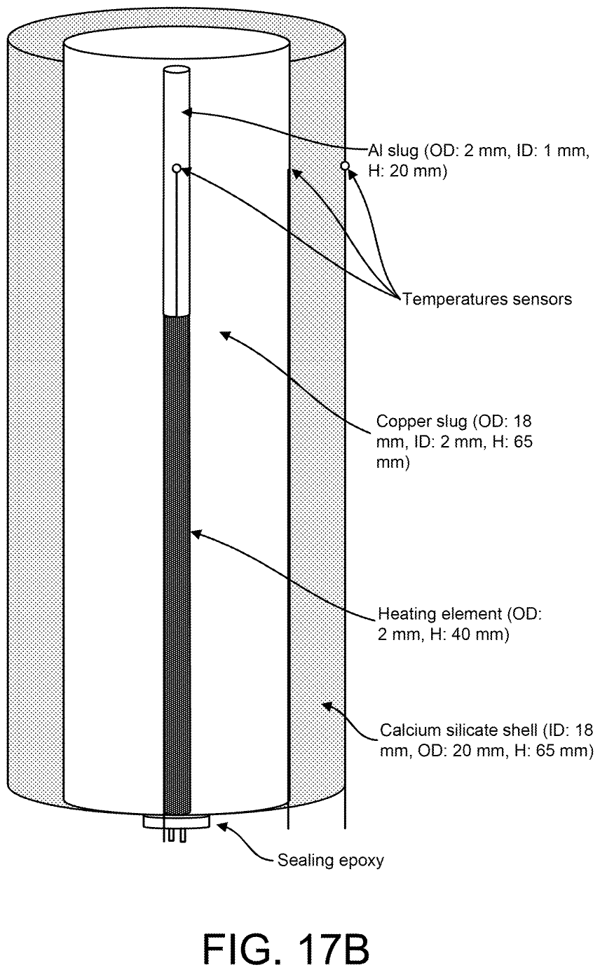

In this example, the components of additional modules (calorimeter system) for real-time thermal behavior analysis of a test electrochemical energy storage device are described and shown in FIGS. 17A-17B. In this example, the test electrochemical energy storage device can be any device disclosed herein. For example, and without limitations, the test electrochemical energy storage device can be a cylindrical cell, as shown in FIG. 17A and comprising an aluminum slug drilled halfway through its length; one or more temperature sensors, a heating device, and a hollowed-out calcium silicate shell. For a 18650 cell, it can have a height of 65 mm and an inner and outer diameter of 18 and 20 mm, respectively. The shell encases the test electrochemical energy storage device to reduce heat loss. In general, such a heater insertion system can be created around any cylindrical format (18650, 2170, 4680, etc.) cells. Dimensions of the shell and other internal components can be adjusted accordingly. Interior and exterior temperature measurements can also be made on the calcium silicate shell.

A benchmarking system was also created for the calorimeter system, as shown in FIG. 17B. The system comprises a copper slug with the same geometry and dimensions as the cylindrical cell used in the heater-insertion system. The copper slug also contains the aluminum slug similar to the one used in the test electrochemical energy storage device, temperature-measuring sensor and heater device and is encased in a calcium silicate shell similar to the one used in the test electrochemical energy storage device. The thermophysical properties of the copper slug are known, and thus, they can be used as the baseline sample for calorimetry tests. The system can serve as a nonreactive proxy (“nominal system”) to the real heater-insertion system. The dimensions of the benchmarking system can also be tailored to those of the heater-insertion system (depending on the cylindrical cell) to have the same mass.

### Example 6

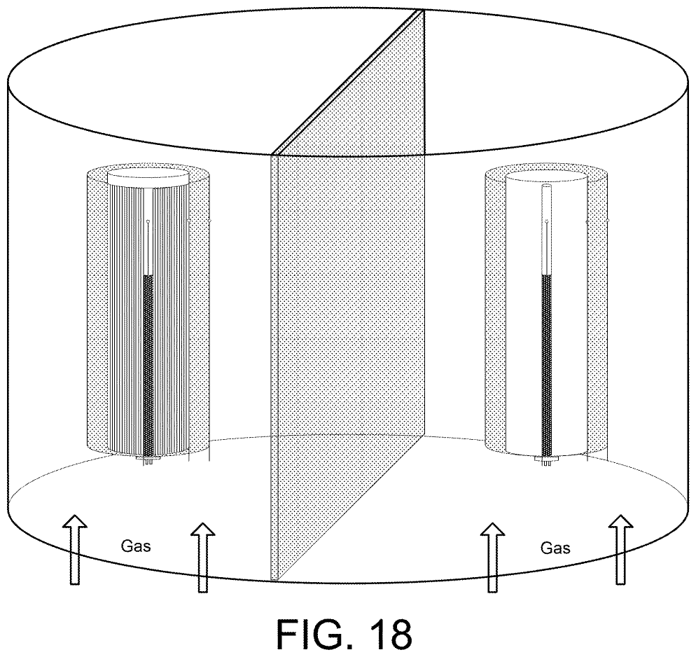

FIG. 18 shows an exemplary module for the calorimetric tests. The test electrochemical energy storage device (referred herein as a heater-insertion system) and a benchmarking system as described in Example 5 and shown in FIGS. 17A-17B are placed into a container. The container can be, for example, a tube or duct environment with an inner diameter of 150 mm and a thermally-insulated board partitioning the container into two equal sections.

Gas (air or nitrogen) is supplied into the container apparatus at a steady flow rate to establish a stable and known convection coefficient in the environment. The test conditions need to be identical for both the heater-insertion and benchmarking systems.

In this example, the two systems are not thermally interacting with each other due to the thermally-insulated partition board.

Calorimetry test is performed for both systems by simultaneously activating the heating elements. The temperature history profiles from both systems are collected. Because the benchmarking system's properties are known, it is used as the calibration benchmark to determine the thermo-physical properties of the heater-insertion system at a fully discharged condition (0% SOC). A computational model can be further developed for the test systems and implemented to interpret the temperature data and calculate its properties based on the difference in the temperature curves.

Knowing the heater-insertion system's thermo-physical properties at 0% SOC, the internal heat generation at higher SOCs can be determined similarly by performing the same procedure. The internal heat generation from exothermic electrochemical reactions at high SOCs leads to a temperature increase. Hence, the temperature data can also be imported into the software to determine the internal heat generation of the heater-insertion system at any SOC. This functionality of the calorimetry test apparatus is designed to be a more cost-effective substitute for accelerating rate calorimetry.

### Conclusion

The performance check of the modified 18650 cells showed that the majority of (more than 20) modified cells preserved their performance. The profiles showed that their states of health were not altered due to mechanical modifications and had the same charge capacity as the original cells. Failure tube tests showed that the internal heater cartridge was able to provide sufficient and consistent heating to initiate thermal runaway. The heating rates from the internal heating tests are relatively more repeatable than those from the traditional external heating methodology. In addition, modified cells showed similar thermal runaway behavior and damage to those failed in realistic manners and are representative of “real-world” cell failures. However, the path to thermal runaway was shown to be different. Cells in the external heating cases experienced a longer duration of venting, while cells in the internal heating cases experienced a shorter duration of venting before thermal runaway.

Without wishing to be bound by any theory, it was hypothesized that the externally heated cells are of uniform higher temperatures, leading to higher electrolyte temperature and pressure at the venting time. The mass loss tests show that a cell's mass changes in the duration of heating to thermal runaway and how it depends on different heating methodologies. Overall, the mass loss of the cells in the tests is consistent with observations from the failure tube tests. The internally heated cells did not lose mass (vent) prior to the thermal runaway, while the externally heated cells continuously lost mass due to gas venting. These data show that the internal heating methodology affects a cell's internal failure differently. The application of modified cell in a package of cells showed how this heater-insertion technique might be used in other failure applications. Once the internal heating was imitated in one of the cells (near the center of the power bank), the thermal runaway was eventually induced and propagated to the cells in the venting direction. The cells in the opposite direction (cells 1 and 2) were less thermally affected and thus did not go into thermal runaway. Overall, this proved that the modified cell can also be integrated with large enclosures to simulate battery failure in commercial power packages in a controllable manner.

### EXEMPLARY ASPECTS

Example 1: A system comprising: at least one test electrochemical energy storage device having an internal compartment and an external surface, wherein the internal compartment comprises: i) a negative electrode; ii) a positive electrode; iii) a temperature sensor; and iv) a heating device; wherein the temperature sensor and the heating device are positioned within at least a portion of the internal compartment of the at least one test electrochemical energy storage device; and wherein the system is configured to initiate internal reactions and trigger thermal runaway of the at least one test electrochemical energy storage device and/or one or more electrochemical energy storage devices.

Example 2: The system of any examples herein, particularly example 1, wherein the at least one test electrochemical energy storage device is cylindrical.

Example 3: The system of any examples herein, particularly examples 1 or 2, wherein the heating device is positioned in a center of the internal compartment of the at least one test electrochemical energy storage device.

Example 4: The system of any examples herein, particularly examples 1-3, wherein the temperature sensor is positioned in a center of the internal compartment of the at least one test electrochemical energy storage device.

Example 5: The system of any examples herein, particularly examples 1-4, wherein the heating device is configured to heat the internal compartment of the at least one test electrochemical energy storage device to a predetermined temperature.

Example 6: The system of any examples herein, particularly example 5, wherein the predetermined temperature is from about 60° C. to about 1,500° C.

Example 7: The system of any examples herein, particularly examples 1-6, wherein the one or more electrochemical energy storage devices have substantially identical geometry to the at least one test electrochemical energy storage device.

Example 8: The system of any examples herein, particularly examples 1-7, wherein the one or more electrochemical energy storage devices have a substantially identical composition as compared to the at least one test electrochemical energy storage device in the absence of at least the heating device and/or the temperature sensor.

Example 9: The system of any examples herein, particularly examples 1-8, wherein the one or more electrochemical energy storage devices exhibit substantially identical electrical properties as the at least one test electrochemical energy storage device.

Example 10: The system of any examples herein, particularly examples 1-9, further comprising a control unit.

Example 11: The system of any examples herein, particularly examples 1-10, wherein the at least one test electrochemical energy storage device is in electrical communication with a surrogate cell heater element.

Example 12: The system of any examples herein, particularly example 11, wherein the at least one test electrochemical energy storage device and the surrogate cell heater element are configured to be heated independently to a first temperature and a second temperature, respectively.

Example 13: The system of any examples herein, particularly example 12, wherein the first temperature and the second temperature are the same.

Example 14: The system of any examples herein, particularly examples 1-13, wherein the external surface of the at least one test electrochemical energy storage device and the internal compartment of the at least one test electrochemical energy storage device are configured to be heated independently to a third temperature and a fourth temperature, respectively.

Example 15: The system of any examples herein, particularly example 14, wherein the third and fourth temperatures are the same.

Example 16: The system of any examples herein, particularly examples 1-15, wherein the system is configured to provide calorimetric characteristics of the at least one test electrochemical energy storage device.

Example 17: The system of any examples herein, particularly examples 1-16, wherein the system is configured to characterize thermal properties, reactive/kinetic properties, a degradation path, and/or stability of active materials in the at least one test electrochemical energy storage device.

Example 18: The system of any examples herein, particularly examples 1-17, wherein the system is configured to model thermal properties, reactive/kinetic properties, a degradation path, and/or stability of active materials of the one or more electrochemical energy storage devices.

Example 19: The system of any examples herein, particularly examples 1-18, wherein the system further comprises the one or more electrochemical energy storage devices.

Example 20: The system of any examples herein, particularly examples 1-19, wherein the at least one test electrochemical energy storage device and the one or more electrochemical energy storage devices are lithium-ion cells.

Example 21: The system of any examples herein, particularly examples 1-20, wherein the at least one test electrochemical energy storage device and the one or more electrochemical energy storage devices are cylindrical lithium-ion cells.

Example 22: The system of any examples herein, particularly examples 1-21, wherein the system is fail-safe.

Example 23: A method comprising: a providing at least one test electrochemical energy storage having an internal compartment and an external surface, wherein the internal compartment comprises: i) a negative electrode; ii) a positive electrode; iii) a temperature sensor; and iv) a heating device; wherein the temperature sensor and heating device are positioned within at least a portion of the internal compartment of the at least one test electrochemical energy storage device; and b) heating the at least one test electrochemical energy storage device to cause an internal failure.

Example 24: The method of any examples herein, particularly example 23, wherein the at least one test electrochemical energy device is cylindrical.

Example 25: The method of any examples herein, particularly examples 23 or 24, wherein the heating device is positioned in a center of the internal compartment of the at least one test electrochemical energy storage device.

Example 26: The method of any examples herein, particularly examples 23-25, wherein the temperature sensor is positioned in a center of the internal compartment of the at least one test electrochemical energy storage device.

Example 27: The method of any examples herein, particularly examples 23-26, wherein the step of heating comprises bringing the internal compartment of the at least one test electrochemical energy storage device to a first predetermined temperature by heating the heating device.

Example 28: The method of any examples herein, particularly example 27, wherein the first predetermined temperature is from about 60° C. to about 1,500° C.

Example 29: The method of any examples herein, particularly examples 23-28, wherein the method further comprises measuring one or more of thermal properties, reactive/kinetic properties, a degradation path, and/or stability of active materials in the at least one test electrochemical energy storage device.

Example 30: The method of any examples herein, particularly examples 23-29, wherein the method further comprises a step of modeling one or more of thermal properties, reactive/kinetic properties, a degradation path, and/or stability of active materials of one or more electrochemical energy storage devices that are substantially identical to the at least one test electrochemical energy storage device with the absence of at least the heating device and/or the temperature sensor.

Example 31: The method of any examples herein, particularly examples 23-30, wherein the at least one test electrochemical energy storage device is formed by inserting the temperature sensor and the heating device into at least a portion of an internal compartment of one or more electrochemical energy storage devices.

Example 32: The method of any examples herein, particularly examples 23-31, wherein the at least one test electrochemical energy storage device and one or more electrochemical energy storage devices are lithium-ion cells.

Example 33: The method of any examples herein, particularly examples 23-32, wherein the at least one test electrochemical energy storage device and the one or more electrochemical energy storage devices are cylindrical lithium-ion cells.

Example 34: The method of any examples herein, particularly examples 30-33, wherein the one or more electrochemical energy storage devices are fully discharged to a predetermined voltage prior to insertion of the temperature sensor and the heating device.

Example 35: The method of any examples herein, particularly examples 27-34, wherein the method further comprises heating the external surface of the at least one test electrochemical energy storage device to a second predetermined temperature wherein the first and the second predetermined temperatures are the same or different.

Example 36: The method of any examples herein, particularly example 35, wherein the method provides for calorimetric properties of the at least one test electrochemical energy storage device.

Example 37: The method of any examples herein, particularly examples 31-36, wherein electrical properties of the one or more electrochemical energy storage devices before insertion of the heating device and the temperature sensor are substantially identical to electrical properties of the at least one test electrochemical energy storage device.

Example 38: The method of any examples herein, particularly examples 23-37, wherein the at least one test electrochemical energy storage device is in electrical communication with a control unit.

Example 39: The method of any examples herein, particularly examples 23-38, further comprising independently heating a surrogate cell heater element that is in electrical communication with the at least one test electrochemical energy storage device to measure calorimetric properties of the at least one test electrochemical energy storage device.

Example 40: The method of any examples herein, particularly example 39, wherein the at least one test electrochemical energy storage device and the surrogate cell heater element are configured to be heated independently to a first temperature and a second temperature, respectively.

Example 41: The method of any examples herein, particularly example 40, wherein the first temperature and the second temperature are the same.

Example 42: The method of any examples herein, particularly examples 23-41, further comprising inserting the at least one test electrochemical energy storage device into a pack comprising the one or more electrochemical energy storage devices.

Example 43: The method of any examples herein, particularly example 42, wherein the step of heating comprises a thermal runaway failure of the one or more electrochemical energy storage devices in the pack.

Example 44: The method of any examples herein, particularly examples 23-43, wherein the method is fail-safe.

Example 45: A module for real-time thermal behavior analysis of a test electrochemical energy storage device, the module comprising: a) the test electrochemical energy storage device; b) a high thermal conductivity surrogate heater element; and c) a control unit that is in electrical communication with the test electrochemical energy storage device and the high thermal conductivity surrogate heater element and is configured to heat the test electrochemical energy storage device and the high thermal conductivity surrogate heater element independently to a first predetermined temperature and a second predetermined temperature respectively, and wherein the control unit is further configured to collect and process data to analyze the thermal behavior of the test electrochemical energy storage device, wherein the test electrochemical energy storage device has an internal compartment and an external surface, wherein the internal compartment comprises: i) a negative electrode; ii) a positive electrode; iii) a temperature sensor; and iv) a heating device; wherein the temperature sensor and the heating device are positioned within at least a portion of the internal compartment of the at least one test electrochemical energy storage device.

Example 46: The module of any examples herein, particularly example 45, wherein the test electrochemical energy device is cylindrical.

Example 47: The module of any examples herein, particularly examples 45 or 46, wherein the high thermal conductivity surrogate heater element is cylindrical and has a geometry substantially identical to the test electrochemical energy device.

Example 48: The module of any examples herein, particularly examples 45-47, wherein the heating device is positioned in a center of the internal compartment of the test electrochemical energy storage device.

Example 49: The module of any examples herein, particularly examples 45-48, wherein the temperature sensor is positioned in a center of the internal compartment of the test electrochemical energy storage device.

Example 50: The module of any examples herein, particularly examples 45-49, wherein the test electrochemical energy storage device and/or the high thermal conductivity surrogate heater element are inserted into an insulating shell.

Example 51: The module of any examples herein, particularly example 50, wherein the insulating shell comprises calcium silicate.

Example 52: The module of any examples herein, particularly examples 45-51, wherein the heating device is configured to heat the internal compartment of the test electrochemical energy storage device to the first predetermined temperature.

Example 53: The module of any examples herein, particularly example 52, wherein the first predetermined temperature is from about 60° C. to about 1,500° C.

Example 54: The module of any examples herein, particularly examples 45-53, wherein the first predetermined temperature and the second predetermined temperature are the same.

Example 55: The module of any examples herein, particularly examples 45-53, wherein the external surface of the test electrochemical energy storage device and the internal compartment of at least one test electrochemical energy storage device are configured to be heated independently to a third and a fourth temperature, respectively.

Example 56: The module of any examples herein, particularly example 55, wherein the third and the fourth temperatures are the same.

Example 57: The module of any examples herein, particularly examples 45-56, wherein the module is configured to provide calorimetric characteristics of the test electrochemical energy storage device.

Example 58: The module of any examples herein, particularly examples 45-57, wherein the test electrochemical energy storage device is lithium-ion cells.

Example 59: The module of any examples herein, particularly examples 45-58, wherein the control unit is configured to process one or more heating temperature data, power-temperature data, or power-time data to develop a power function representative of a thermal power of the test electrochemical energy storage device.

Example 60: The module of any examples herein, particularly examples 45-59, wherein the module is positioned in a compartment, wherein the compartment is a gas flow-through compartment.

Example 61: The module of any examples herein, particularly example 60, wherein the gas flow-through compartment is configured to keep the module in a steady state.

Example 62: The module of any examples herein, particularly examples 60-61, wherein the compartment further comprises at least one barrier, thus creating at least two separate sub-compartments, wherein a first sub-compartment comprises the test electrochemical energy storage device and a second sub-compartment comprises the high thermal conductivity surrogate heater element, and wherein the first and the second sub-compartments are thermally isolated from each other.

Example 63: A method of analyzing a thermal behavior of the test electrochemical energy storage device of any examples herein, particularly examples 45-62, the method comprising: a) heating the internal compartment to a temperature; b) equilibrating a temperature of the external surface of the test electrochemical energy storage device with the temperature of the internal compartment; c) heating a high thermal conductivity surrogate heater element to match the temperature of the external surface of the test electrochemical energy storage device; d) continue heating the internal compartment until a thermal runaway of the test electrochemical energy storage device is initiated; e) heating a surface of the high thermal conductivity surrogate heater element to match a temperature of up to a predetermined value of the test electrochemical energy storage device; and f) estimating the thermal behavior of the test electrochemical energy storage device.

Example 64: The method of any examples herein, particularly example 63, wherein the heating of the internal compartment to a temperature is step and hold heating which is repeated until the thermal runaway is initiated.

Example 65: The method of any examples herein, particularly examples 63-649, wherein the method further comprises measuring a power of the high thermal conductivity surrogate heater element during the heating step c).

Example 66: The method of any examples herein, particularly examples 63-65, wherein when the thermal runaway of the test electrochemical energy storage device is initiated, the heating of the internal compartment is stopped.

Example 67: The method of any examples herein, particularly examples 63-66, wherein the module is positioned in a gas flow-through compartment.

Example 68: The method of any examples herein, particularly example 67, wherein the compartment further comprises at least one barrier, thus creating at least two separate sub-compartments, wherein a first sub-compartment comprises the test electrochemical energy storage device and a second sub-compartment comprises the high thermal conductivity surrogate heater element, and wherein the first and the second sub-compartments are thermally isolated from each other.

Example 69: The method of any examples herein, particularly examples 67-68, wherein the gas is supplied at a predetermined flow rate.

Example 70: The method of any examples herein, particularly example 68, wherein the gas is supplied to the first and the second sub-compartment at a substantially the same predetermined flow rate.

Example 71: The method of any examples herein, particularly examples 63-70, wherein the step of the estimating comprising using a thermal model that could be in an analytical form, computational form, or data-driven form, with known physical and thermal properties and calibrated electrochemical parameters to establish the thermal behavior of the test electrochemical energy storage device given specified test conditions.

Example 72: A module for real-time thermal behavior analysis of a test electrochemical energy storage device, the module comprising: a) a test electrochemical energy storage device having has an internal compartment and an external surface, wherein the internal compartment comprises: i) a negative electrode; ii) a positive electrode; iii) a temperature sensor; and iv) a heating device; wherein the temperature sensor and the heating device are positioned within at least a portion of the internal compartment of the at least one test electrochemical energy storage device; and b) a control unit that is in electrical communication with the test electrochemical energy storage device and that is configured to independently heat the internal compartment and the external surface of the test electrochemical energy storage device to a first temperature and to a second temperature, respectively, and wherein the control unit is further configured to collect and process data to analyze the thermal behavior of the test electrochemical energy storage device.

Example 73: The module of any examples herein, particularly example 72, wherein the test electrochemical energy device is cylindrical.

Example 74: The module of any examples herein, particularly examples 72-73, wherein the heating device is positioned in a center of the internal compartment of the test electrochemical energy storage device.

Example 75: The module of any examples herein, particularly examples 72-74, wherein the temperature sensor is positioned in a center of the internal compartment of the test electrochemical energy storage device.

Example 76: The module of any examples herein, particularly example 75, wherein the first temperature is from about 60° C. to about 1,500° C.

Example 77: The module of any examples herein, particularly examples 72-76, wherein the first predetermined temperature and the second temperature are the same.

Example 78: The module of any examples herein, particularly examples 72-77, wherein the test electrochemical energy storage device is inserted into an insulating shell.

Example 79: The module of any examples herein, particularly example 78, wherein the insulating shell comprises calcium silicate.

Example 80: The module of any examples herein, particularly examples 72-79, wherein the module is configured to provide calorimetric characteristics of the test electrochemical energy storage device.

Example 81: The module of any examples herein, particularly examples 72-80, wherein the test electrochemical energy storage device is lithium-ion cells.

Example 82: A method of analyzing a thermal behavior of the test electrochemical energy storage device of any examples herein, particularly examples 72-81, the method comprising: a) heating the internal compartment to a temperature; b) heating the external surface of the test electrochemical energy storage device to match the temperature of the internal compartment of the test electrochemical energy storage device; c) continue heating the internal compartment until a thermal runaway of the test electrochemical energy storage device is initiated; and d) estimating the thermal behavior of the test electrochemical energy storage device.

Example 83: The method of any examples herein, particularly example 82, wherein the heating of the internal compartment to a temperature is step and hold heating which is repeated until the thermal runaway is initiated.

Example 84: The method of any examples herein, particularly examples 82-83, wherein the method further comprises measuring a power of a heater used to heat the external surface of the test electrochemical energy storage device.

Example 85: The method of any examples herein, particularly examples 82-84, wherein when the thermal runaway of the test electrochemical energy storage device is initiated, the heating of the internal compartment is stopped.

Example 86: The method of any examples herein, particularly examples 82-85, wherein the module is positioned in a gas flow-through compartment.

Example 87: The method of any examples herein, particularly example 86, wherein the gas is supplied at a predetermined flow rate.

Example 88: The method of any examples herein, particularly examples 72-87, wherein the step of the estimating comprising using a thermal model that could be in an analytical form, computational form, or data-driven form, with known physical and thermal properties and calibrated electrochemical parameters to establish the thermal behavior of the test electrochemical energy storage device given specified test conditions.

The devices, systems, and methods of the appended claims are not limited in scope by the specific devices, systems, and methods described herein, which are intended as illustrations of a few aspects of the claims. Any devices, systems, and methods that are functionally equivalent are intended to fall within the scope of the claims. Various modifications of the devices, systems, and methods, in addition to those shown and described herein, are intended to fall within the scope of the appended claims. Further, while only certain representative devices, systems, and method steps disclosed herein are specifically described, other combinations of the devices, systems, and method steps also are intended to fall within the scope of the appended claims, even if not specifically recited. Thus, a combination of steps, elements, components, or constituents may be explicitly mentioned herein or less; however, other combinations of steps, elements, components, and constituents are included, even though not explicitly stated.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove and that many modifications and other embodiments are intended to be included within the scope of the appended claims. Moreover, although specific terms are employed herein, as well as in the claims which follow, they are used only in a generic and descriptive sense and not for the purposes of limiting the described invention or the claims which follow.

Unless defined otherwise, all technical and scientific terms used herein have the same meanings as commonly understood by one of skill in the art to which the disclosed invention belongs. Publications cited herein and the materials for which they are cited are specifically incorporated by reference.

The claims are not intended to include, and should not be interpreted to include, means-plus- or step-plus-function limitations unless such a limitation is explicitly recited in a given claim using the phrase(s) “means for” or “step for,” respectively.

In view of the described processes and compositions, hereinbelow are described certain more particularly described aspects of the inventions. These particularly recited aspects should not, however, be interpreted to have any limiting effect on any different claims containing different or more general teachings described herein or that the “particular” aspects are somehow limited in some way other than the inherent meanings of the language and formulas literally used therein.

### REFERENCES

[1] T. M. Bandhauer, S. Garimella, T. F. Fullerb, A critical review of thermal issues in lithium-ion batteries, Journal of The Electrochemical Society 158 (3) (2011) R1-R25. doi:https://doi.org/10.1149/1.3515880.
[2] P. J. Bugryniec, J. N. Davidson, S. F. Brown, Assessment of thermal runaway in commercial lithium iron phosphate cells due to overheating in an oven test, Energy Procedia 151 (2018) 74-78. doi:https://doi.org/10.1016/j.egypro.2018.09.030.
[3] J. Zhu, X. Zhang, E. Sahraei, T. Wierzbicki, Deformation and failure mechanisms of 18650 battery cells under axial compression, Journal of Power Sources 336 (2016) 332-340. doi:https://doi.org/10.1016/j.jpowsour.2016.10.064.
[4] P. E. Roth, D. H. Doughty, D. L. Pile, Effects of separator breakdown on abuse response of 18650 li-ion cells, Journal of Power Sources 174 (2) (2007) 579-583. doi:https://doi.org/10.1016/j.jpowsour.2007.06.163.
[5] Z. Hu, X. He, F. Restuccia, G. Rein, Numerical study of self-heating ignition of a box of lithium-ion batteries during storage, Fire Technology (2020) 1-19. doi:https://doi.org/10.1007/s10694-020-00998-8.
[6] X. He, F. Restuccia, Y. Zhang, Z. Hu, X. Huang, J. Fang, G. Rein, Experimental study of self-heating ignition of lithium-ion batteries during storage: Effect of the number of cells, Fire Technology (2020) 121doi:https://doi.org/10.1007/s10694-020-01011-y.
[7] L. Liu, X. Feng, M. Zhang, L. Lu, X. Han, X. He, M. Ouyang, Comparative study on substitute triggering approaches for internal short circuit in lithium-ion batteries, Journal of Applied Energy 259 (2020) 114143.
[8] D. P. Finegan, E. Darcy, M. Keyser, B. Tjaden, T. M. M. Heenan, R. Jervis, J. J. Bailey, R. Malik, N. T. Vo, O. V. Magdysyuk, R. Atwood, M. Drakopoulos, M. DiMichiel, A. Rack, G. Hinds, D. J. L. Brett, P. R. Shearing, Characterising thermal runaway within lithium-ion cells by inducing and monitoring internal short circuits, Journal of Energy and Environmental Science 10 (6) (2017) 1377-1388. doi:https://doi.org/10.1039/C7EE00385D.
[9] H. Yan, K. C. Marr, O. A. Ezekoye, Towards fire forensic characteristics of failed cylindrical format lithium-ion cells and batteries, Journal of Fire Technology (2021). doi:https://doi.org/10.1007/s10694-020-01079-6.
[10] SAMSUNG SDI Co., Ltd., Safety data sheet, Tech. rep. (January 2016).
[11] J. Sturm, A. Rheinfeld, I. Zilberman, F. Spingler, S. Kosch, F. Frie, A. Jossen, Modeling and simulation of inhomogeneities in a 18650 nickel-rich, silicon-graphite lithium-ion cell during fast charging, Journal of Power Sources 412 (2019) 204-223. doi:https://doi.org/10.1016/j.jpowsour.2018.11.043.
[12] B. Mao, P. Huang, H. Chen, Q. Wang, J. Sun, Self-heating reaction and thermal runaway criticality of the lithium ion battery, International Journal of Heat and Mass Transfer 149 (2020) 119178. doi:https://doi.org/10.1016/j.ijheatmasstransfer.2019.119178.
[13] J. Liu, Z. Wang, J. Gong, K. Liu, H. Wang, L. Guo, Experimental study of thermal runaway process of 18650 lithium-ion battery, Materials 10 (3) (2017) 230. doi:https://doi.org/10.3390/ma10030230.
[14] D. Noelle, M. Wang, A. Le, Y. Shi, Y. Qiao, Internal resistance and polarization dynamics of lithium-ion batteries upon internal shorting, Applied Energy 212 (2018) 796-808. doi:https://doi.org/10.1016/j.apenergy.2017.12.086.
[15] M. Zhang, J. Du, L. Liu, A. Stefanopoulou, J. Siegel, L. Lu, X. He, X. Xie, M. Ouyang, Internal short circuit trigger method for lithium-ion battery based on shape memory alloy, Journal of The Electrochemical Society 164 (13) (2017) A3038. doi:https://doi.org/10.1149/2.0731713jes.
[16] E. Darcy, Insights from safety tests with an on-demand internal short circuit device in 18650 cells (2017).
[17] M. Chen, D. Zhou, X. Chen, W. Zhang, J. Liu, R. Yuen, J. Wang, Investigation on the thermal hazards of 18650 lithium ion batteries by fire calorimeter, Journal of Thermal Analysis and calorimetry volume 122 (2) (2015) 755-763. doi:https://doi.org/10.1007/s10973-015-4751-5.
[18] A. W. Golubkov, D. Fuchs, J. Wagner, H. Wiltsche, C. Stangl, G. Fauler, G. Voitic, A. Thaler, V. Hacker, Thermal-runaway experiments on consumer li-ion batteries with metal-oxide and olivin-type cathodes, RSCAdvances 4 (7) (2014) 3633-3642.doi:https://doi.org/10.1039/c3ra45748f.

1.-88. (canceled)

89. A module for real-time thermal behavior analysis of a test electrochemical energy storage device, the module comprising:
a) a test electrochemical energy storage device having an internal compartment and an external surface, wherein the internal compartment comprises:
i) a negative electrode;
ii) a positive electrode;
iii) a temperature sensor; and
iv) a heating device;
wherein the temperature sensor and the heating device are positioned within at least a portion of the internal compartment of the at least one test electrochemical energy storage device; and
b) a control unit that is in electrical communication with the test electrochemical energy storage device and that is configured to independently heat the internal compartment and the external surface of the test electrochemical energy storage device to a first temperature and to a second temperature, respectively, and wherein the control unit is further configured to collect and process data to analyze the thermal behavior of the test electrochemical energy storage device.

90. The module of claim 89, wherein the heating device and the temperature sensor are positioned in a center of the internal compartment of the test electrochemical energy storage device.

91. The module of claim 89, wherein the first predetermined temperature and the second temperature are the same and are from about 60° C. to about 1,500° C.

92. The module of claim 89, wherein the module is configured to provide calorimetric characteristics of the test electrochemical energy storage device.

93. A module for real-time thermal behavior analysis of a test electrochemical energy storage device, the module comprising:
a) the test electrochemical energy storage device;
b) a high thermal conductivity surrogate heater element; and
c) a control unit that is in electrical communication with the test electrochemical energy storage device and the high thermal conductivity surrogate heater element and is configured to heat the test electrochemical energy storage device and the high thermal conductivity surrogate heater element independently to a first predetermined temperature and a second predetermined temperature respectively, and wherein the control unit is further configured to collect and process data to analyze the thermal behavior of the test electrochemical energy storage device, wherein
the test electrochemical energy storage device has an internal compartment and an external surface, wherein the internal compartment comprises:
i) a negative electrode;
ii) a positive electrode;
iii) a temperature sensor; and
iv) a heating device;
wherein the temperature sensor and the heating device are positioned within at least a portion of the internal compartment of the at least one test electrochemical energy storage device.

94. The module of claim 93, wherein the high thermal conductivity surrogate heater element has a geometry substantially identical to the test electrochemical energy device.

95. The module of claim 93, wherein the external surface of the test electrochemical energy storage device and the internal compartment of at least one test electrochemical energy storage device are configured to be heated independently to a third and a fourth temperature, respectively.

96. The module of claim 93, wherein the module is configured to provide calorimetric characteristics of the test electrochemical energy storage device.

97. The module of claim 93, wherein the control unit is configured to process one or more heating temperature data, power-temperature data, or power-time data to develop a power function representative of a thermal power of the test electrochemical energy storage device.

98. The module of claim 93, wherein the module is positioned in a compartment, wherein the compartment is a gas flow-through compartment.

99. The module of claim 98, wherein the compartment further comprises at least one barrier, thus creating at least two separate sub-compartments, wherein a first sub-compartment comprises the test electrochemical energy storage device and a second sub-compartment comprises the high thermal conductivity surrogate heater element, and wherein the first and the second sub-compartments are thermally isolated from each other.

100. A system comprising:
a) at least one test electrochemical energy storage device having an internal compartment and an external surface, wherein the internal compartment comprises:
i) a negative electrode;
ii) a positive electrode;
iii) a temperature sensor; and
iv) a heating device;
wherein the temperature sensor and the heating device are positioned within at least a portion of the internal compartment of the at least one test electrochemical energy storage device;
b) optionally one or more electrochemical energy storage devices having substantially identical geometry and substantially identical electrical properties as the at least one test electrochemical energy storage device and wherein the one or more electrochemical energy storage devices is having a substantially identical composition as compared to the at least one test electrochemical energy storage device in the absence of at least the heating device and/or the temperature sensor, and
c) a control unit;
wherein the system is configured to initiate internal reactions and trigger thermal runaway of the at least one test electrochemical energy storage device and/or one or more electrochemical energy storage devices.

101. The system of claim 100, wherein the heating device is configured to heat the internal compartment of the at least one test electrochemical energy storage device to a predetermined temperature of about 60° C. to about 1,500° C.

102. The system of claim 100, wherein the at least one test electrochemical energy storage device is in electrical communication with a surrogate cell heater element.

103. The system of claim 102, wherein the at least one test electrochemical energy storage device and the surrogate cell heater element are configured to be heated independently to a first temperature and a second temperature, respectively.

104. The system of claim 100, wherein the external surface of the at least one test electrochemical energy storage device and the internal compartment of the at least one test electrochemical energy storage device are configured to be heated independently to a third temperature and a fourth temperature, respectively.

105. The system of claim 100, wherein the system provides calorimetric characteristics of the at least one test electrochemical energy storage device.

106. The system of claim 100, wherein the system characterizes thermal properties, reactive/kinetic properties, a degradation path, and/or stability of active materials in the at least one test electrochemical energy storage device.

107. The system of claim 100, wherein the system models thermal properties, reactive/kinetic properties, a degradation path, and/or stability of active materials of the one or more electrochemical energy storage devices.

108. A method comprising:
a) providing at least one test electrochemical energy storage having an internal compartment and an external surface, wherein the internal compartment comprises:
i) a negative electrode;
ii) a positive electrode;
iii) a temperature sensor; and
iv) a heating device;
wherein the temperature sensor and heating device are positioned within at least a portion of the internal compartment of the at least one test electrochemical energy storage device; and
b) heating the at least one test electrochemical energy storage device to cause an internal failure;
c) measuring one or more of thermal properties, reactive/kinetic properties, a degradation path, and/or stability of active materials in the at least one test electrochemical energy storage device.

109. The method of claim 108, wherein the method further comprises a step of modeling one or more of thermal properties, reactive/kinetic properties, a degradation path, and/or stability of active materials of one or more electrochemical energy storage devices that are substantially identical to the at least one test electrochemical energy storage device with the absence of at least the heating device and/or the temperature sensor.

110. The method of claim 108, wherein at least one test electrochemical energy storage device is formed by inserting the temperature sensor and the heating device into at least a portion of an internal compartment of one or more electrochemical energy storage devices, and wherein the one or more electrochemical energy storage devices are fully discharged to a predetermined voltage prior to insertion of the temperature sensor and the heating device.

111. The method of claim 108, further comprising inserting the at least one test electrochemical energy storage device into a pack comprising the one or more electrochemical energy storage devices, such that the step of heating comprises a thermal runaway failure of the one or more electrochemical energy storage devices in the pack.
